(19) United States
(12) Patent Application Publication
(10) Pub. No.: US 2023/0014845 A1
(43) Pub. Date: Jan. 19, 2023

(54) PACKAGING PART, PACKAGING ASSEMBLY, AND CHIP READ WRITE METHOD USING PACKAGING PART

(71) Applicant: Ninestar Corporation, Zhuhai (CN)

(72) Inventors: Xiaoqin WU, Zhuhai (CN); Qingfeng CUI, Zhuhai (CN); Genhong CHEN, Zhuhai (CN); Xinghuo XIANG, Zhuhai (CN); Jianxin CAO, Zhuhai (CN); Weichen LIU, Zhuhai (CN); Chengpai FENG, Zhuhai (CN)

(21) Appl. No.: 17/944,105

(22) Filed: Sep. 13, 2022

Related U.S. Application Data
(63) Continuation of application No. PCT/CN2020/099416, filed on Jun. 30, 2020.

(30) Foreign Application Priority Data
Mar. 13, 2020 (CN) 202020317367.7
May 8, 2020 (CN) 202020741365.0

(51) Int. Cl. B65D 5/42; B65D 81/113; B65D 85/68; B41J 2/175

(52) U.S. Cl. CPC B65D 5/4212; B65D 5/4204; B65D 81/113; B65D 85/68; B41J 2/17533; B65D 2585/689

(57) ABSTRACT

The present disclosure provides a packaging part, a packaging assembly and a chip read write method using the packaging part. The packaging part includes a hollow accommodation part, where a size and a shape of the hollow accommodation part is suitable for accommodating a part to-be-packaged; and the part to-be-packaged includes a data storage part; and an operable part, where the data storage part and/or the part to-be-packaged in the hollow accommodation is capable of being operated from an outside of the packaging part through the operable part.

### CROSS-REFERENCE TO RELATED APPLICATION

This application is a continuation application of PCT Patent Application No. PCT/CN2020/099416, filed on Jun. 30, 2020, which claims the priority to Chinese patent application No. 202020317367.7, entitled “Packaging Part”, filed on Mar. 13, 2020, and No. 202020741365.0, entitled “Packaging Part”, filed on May 8, 2020, in the China National Intellectual Property Administration, the entirety of which is incorporated herein by its reference.

### TECHNICAL FIELD

The present disclosure generally relates to the field of image-forming technology and, more particularly, relates to a packaging part, a packaging assembly, and a chip read write method using the packaging part.

### BACKGROUND

Image forming devices such as laser printers and inkjet printers are equipped with consumable cartridges such as developing cartridges and ink cartridges. Consumable cartridges circulating in the market have different structures due to different models and printing performance (such as the maximum number of printed pages and the remaining amount of developer inside the consumable cartridge). Therefore, each consumable cartridge normally carries data of the model of the consumable cartridge, related printing performance and the like. In addition, when the consumable cartridge is recycled after being consumed and the consumable cartridge is reworked, read and write operations including rewriting, rewriting, resetting and the like are performed on above data. Normally, the above data is stored in the consumable chip in the form of a serial number, and the consumable chip is installed on the corresponding consumable cartridge. When the data of the consumable cartridge needs to be read and written, it is necessary to use relevant data read and write device to electrically connect with the consumable chip of the consumable cartridge. When the consumable cartridge is completely packaged, the consumable cartridge needs to be unpackaged; and after the read and write operation is completed, the consumable cartridge needs to be re-packaged if needed, which may complicate read and write operations and consume a large amount of time and labor.

### SUMMARY

One aspect of the present disclosure provides a packaging part. The packaging part includes a hollow accommodation part, where a size and a shape of the hollow accommodation part is suitable for accommodating a part to-be-packaged; and the part to-be-packaged includes a data storage part; and an operable part, where the data storage part and/or the part to-be-packaged in the hollow accommodation is capable of being operated from an outside of the packaging part through the operable part.

Another aspect of the present disclosure provides a packaging assembly. The packaging assembly includes a packaging part and a part to-be-packaged. The packaging part includes a hollow accommodation part, where a size and a shape of the hollow accommodation part is suitable for accommodating a part to-be-packaged; and the part to-be-packaged includes a data storage part; and an operable part, where the data storage part and/or the part to-be-packaged in the hollow accommodation is capable of being operated from an outside of the packaging part through the operable part.

Another aspect of the present disclosure provides a chip read and write method. The method is configured to read and write data of a data storage part in a packaging assembly; the packaging assembly includes a packaging part; the packaging part includes the data storage part; and the packaging part is disposed with an operable part. The method includes placing the packaging assembly on an operating table; identifying a position of the packaging assembly; and according to an identification result, determining whether adjusting a placement position of the packaging assembly relative to the operating table and/or a position of the packaging assembly relative to the data read and write device is needed; and electrically connecting the data storage part with the data read and write device through the operable part.

Other aspects of the present disclosure may be understood by those skilled in the art in light of the description, the claims, and the drawings of the present disclosure.

### BRIEF DESCRIPTION OF THE DRAWINGS

To clearly describe the technical solutions of various embodiments of the present disclosure, the drawings need to be used for describing various embodiments are described below. Obviously, the drawings in the following description are merely some embodiments of the present disclosure. For those skilled in the art, other drawings may be obtained in accordance with these drawings without creative efforts.

FIG. 1 illustrates a three-dimensional schematic of a consumable cartridge which is a developing cartridge according to exemplary embodiments of the present disclosure.

FIG. 2 illustrates another three-dimensional schematic of a consumable cartridge which is a developing cartridge according to exemplary embodiments of the present disclosure.

FIG. 3 illustrates an enlarged structural schematic of a consumable chip at a position A of a developing cartridge according to exemplary embodiments of the present disclosure.

FIG. 4A illustrates a structural schematic of a packaging part being a polyhedral structure according to exemplary embodiment one of the present disclosure.

FIG. 4B illustrates a structural schematic of a packaging part being a plastic uptake box structure according to exemplary embodiment one of the present disclosure.

FIG. 5 illustrates a structural schematic after a packaging part packaging parts a developing cartridge according to exemplary embodiment one of the present disclosure.

FIG. 6 illustrates a structural schematic after a packaging part packaging parts a developing cartridge according to exemplary embodiment two of the present disclosure.

FIG. 7 illustrates a structural schematic after a first packaging part packaging parts a developing cartridge according to exemplary embodiment two of the present disclosure.

FIG. 8 illustrates a structural schematic of a left packaging part according to exemplary embodiment two of the present disclosure.

FIG. 9 illustrates a structural schematic of a right packaging part according to exemplary embodiment two of the present disclosure.

FIG. 10 illustrates a structural schematic of a packaging part according to exemplary embodiment three of the present disclosure.

FIG. 11 illustrates a structural schematic of a packaging part according to exemplary embodiment four of the present disclosure.

FIG. 12A illustrates an enlarged structural schematic of a peelable part at a position B according to exemplary embodiment four of the present disclosure.

FIG. 12B illustrates an enlarged structural schematic of a position B after a peelable part is removed according to exemplary embodiment four of the present disclosure.

FIG. 13 illustrates a structural schematic of a packaging part according to exemplary embodiment five of the present disclosure.

FIG. 14 illustrates a structural schematic of a chip packaging part according to exemplary embodiment five of the present disclosure.

FIG. 15 illustrates an exploded structural schematic of a packaging part according to exemplary embodiment five of the present disclosure.

FIG. 16 illustrates another structural schematic of a packaging part according to exemplary embodiment five of the present disclosure.

FIG. 17 illustrates a structural schematic of a packaging part according to exemplary embodiment six of the present disclosure.

FIG. 18A illustrates a structural schematic of a packaging part according to exemplary embodiment seven of the present disclosure.

FIG. 18B illustrates another structural schematic of a packaging part according to exemplary embodiment seven of the present disclosure.

FIG. 18C illustrates a structural schematic after a peelable part is folded according to exemplary embodiment seven of the present disclosure.

FIG. 19A illustrates a structural schematic of a packaging part according to exemplary embodiment eight of the present disclosure.

FIG. 19B illustrates a structural schematic after a peelable part is folded according to exemplary embodiment eight of the present disclosure.

FIG. 20A illustrates a structural schematic of a packaging part according to exemplary embodiment nine of the present disclosure.

FIG. 20B illustrates a structural schematic after a peelable part is folded according to exemplary embodiment nine of the present disclosure.

FIG. 21 illustrates a structural schematic of a packaging part according to exemplary embodiment ten of the present disclosure.

FIG. 22A illustrates a structural schematic of a packaging part according to exemplary embodiment ten of the present disclosure.

FIG. 22B illustrates another structural schematic of a packaging part according to exemplary embodiment ten of the present disclosure.

FIG. 23 illustrates a structural schematic after a packaging part packaging parts a developing cartridge according to exemplary embodiment ten of the present disclosure.

FIG. 24A illustrates a structural schematic of a packaging part being placed on an operating table P according to exemplary embodiment ten of the present disclosure.

FIG. 24B illustrates another structural schematic of a packaging part being placed on an operating table P according to exemplary embodiment ten of the present disclosure.

FIG. 25 illustrates a structural schematic of a packaging part according to exemplary embodiment eleven of the present disclosure.

FIG. 26 illustrates another three-dimensional schematic of a consumable cartridge which is a developing cartridge according to exemplary embodiments of the present disclosure.

FIG. 27 illustrates a three-dimensional schematic of a consumable cartridge which is an ink cartridge according to exemplary embodiments of the present disclosure.

FIG. 28A illustrates a structural schematic of a packaging part according to exemplary embodiment twelve of the present disclosure.

FIG. 28B illustrates another structural schematic of a packaging part according to exemplary embodiment twelve of the present disclosure.

FIG. 29A illustrates a local schematic of an electrical contact location between a consumable chip and a packaging part after a developing cartridge is packaged according to exemplary embodiment twelve of the present disclosure.

FIG. 29B illustrates a rear-side structural schematic of an electrical contact part of a packaging part according to exemplary embodiment twelve of the present disclosure.

FIG. 30 illustrates another local schematic of an electrical contact location between a consumable chip and a packaging part after a developing cartridge is packaged according to exemplary embodiment twelve of the present disclosure.

FIG. 31 illustrates a structural schematic of a packaging part according to exemplary embodiment thirteen of the present disclosure.

FIG. 32 illustrates another structural schematic of a packaging part according to exemplary embodiment thirteen of the present disclosure.

FIG. 33 illustrates a structural schematic after a second packaging part and a first packaging part are sleeve-type packaged according to exemplary embodiment fourteen of the present disclosure.

FIG. 34 illustrates a structural schematic of a first packaging part according to exemplary embodiment fourteen of the present disclosure.

FIG. 35 illustrates a structural schematic of a packaging part according to exemplary embodiment fifteen of the present disclosure.

FIG. 36 illustrates a structural schematic of a packaging part according to exemplary embodiment sixteen of the present disclosure.

### DETAILED DESCRIPTION

To better understand technical solutions of the present disclosure, embodiments of the present disclosure are described in detail with reference to accompanying drawings.

It should be noted that described embodiments are only a part of embodiments of the present disclosure, rather than all embodiments. Based on embodiments in the present disclosure, all other embodiments obtained by those skilled in the art without creative work shall fall within the protection scope of the present disclosure.

The terms used in embodiments of the present disclosure are only for the purpose of describing specific embodiments and are not intended to limit the present disclosure. The singular forms of “a”, “the” and “said” used in embodiments of the present disclosure and the appended claims are also intended to include plural forms, unless the context clearly indicates other meanings.

It may be understood that the term “and/or” used in the specification may only be an association relationship describing associated objects, which means that there may be three types of relationships. For example, A and/or B can mean that: A alone exists, A and B exist at the same time, and B exists alone. In addition, the character “/” in the specification normally indicates that associated objects before and after are in an “or” relationship.

It should be noted that the directional words such as “on”, “under”, “left”, and “right” described in embodiments of the present disclosure are explained from the angles shown in the drawings and should not be construed as a limitation on embodiments of the present disclosure. Furthermore, in the present disclosure, it should also be understood that when an element is referred to as being “on” or “under” another element, the element can not only be directly connected “on” or “under” the other element, but also indirectly connected “on” or “under” another element through an intermediate element.

Embodiment of the present disclosure provides a packaging assembly including a packaging part and a part to-be-packaged. The packaging part may be configured to accommodate the part to-be-packaged; the part to-be-packaged may include a data storage part; the packaging part may include a hollow accommodation part; and the size and shape of the accommodation part may be suitable for accommodating the part to-be-packaged. The part to-be-packaged accommodated in the packaging part may be a consumable cartridge (developing cartridge, ink cartridge, or the like) used in an image forming apparatus, or a set-top box used in an electronic product, or other-type box structure. The data storage part disposed on the part to-be-packaged may be a storage device configured to store liquid or toner capacity of the part to-be-packaged or other related data, and corresponding operations may be performed on the data in the data storage part by a device which is electrically connected to the outside. The data storage part may include different storage devices. Therefore, above-mentioned the part to-be-packaged, and the data storage part disposed on the part to-be-packaged may be a variety of different structures. Corresponding packaging parts may be configured for accommodating the parts to-be-packaged. Based on the sizes and shapes of different parts to-be-packaged and data storage parts, the structural coordination of corresponding packaging parts may be adjusted to adapt the parts to-be-packaged accordingly, which may not be limited herein. In order to further describe the packaging part disposed, the part to-be-packaged may be configured as a consumable cartridge (a developing cartridge, an ink cartridge or the like), and the data storage part may be configured as a consumable chip as an example for specific description in following embodiments.

In embodiments of the present disclosure, basic structure of the image forming apparatus (such as a laser printer, an inkjet printer or the like) may be a conventional design in the field, and the structure of the consumable cartridge (such as a developing cartridge, an ink cartridge or the like) may be conventional designs in the field, unless otherwise specified.

### Exemplary Embodiment One

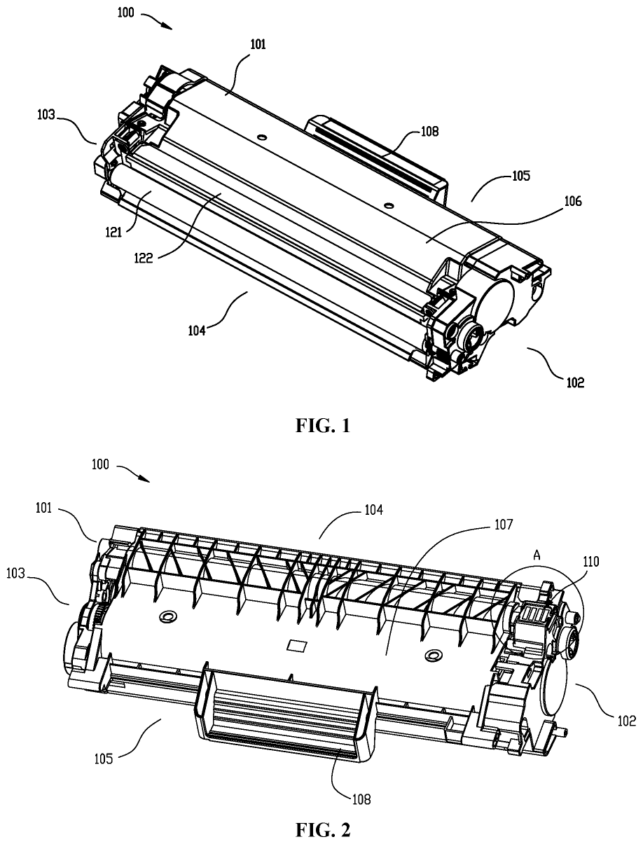

In one embodiment, a packaging part that may be configured to packaging part a consumable cartridge (such as a developing cartridge 100) is provided. A developing cartridge 100 may be detachably installed in the main body of the laser printer; and the developing cartridge 100 may include a cartridge body 101 and a consumable chip 110 on the cartridge body 101. As shown in FIGS. 1-3, along the length direction of the developing cartridge 100, the developing cartridge 100 may include a left end 103 and a right end 102; along the width direction of the developing cartridge 100, the developing cartridge 100 may include a front end 104 and a rear end 105; and along the height direction of the developing cartridge 100, the developing cartridge 100 may include an upper surface 106 and a lower surface 107. The front end 104 of the developing cartridge 100 may be disposed with components such as a developing roller 121 and a developer regulating blade 122; and a handle 108 may also be disposed at the rear end 105 of the developing cartridge 100. The position of the consumable chip 110 disposed on the cartridge body 101 may not be limited. In one embodiment, the consumable chip 110 may be disposed on the lower surface 107 of the cartridge body 101 and adjacent to the right end 102 than the left end 103.

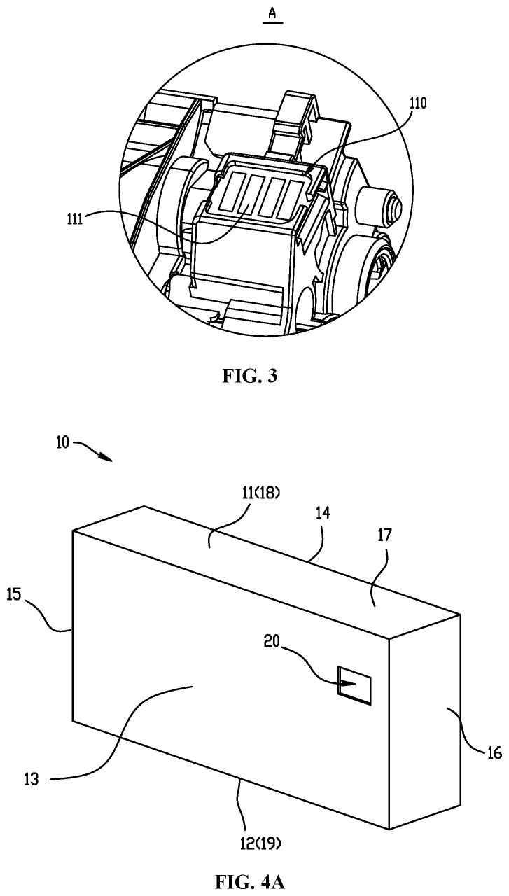

As shown in FIG. 3, at least one chip terminal 111 may be disposed on the consumable chip 110; and data, which may be read and written, may be stored in the consumable chip 110. For example, a memory (not shown) may be included in the consumable chip 110; print information data related to the consumable cartridge may be stored in the memory; the chip terminal 111 may be electrically connected with the memory; the data in the memory be may read and written after the chip terminal 111 is powered on; and the reading and writing may include operations such as rewriting, rewriting, upgrading, resetting of data and the like.

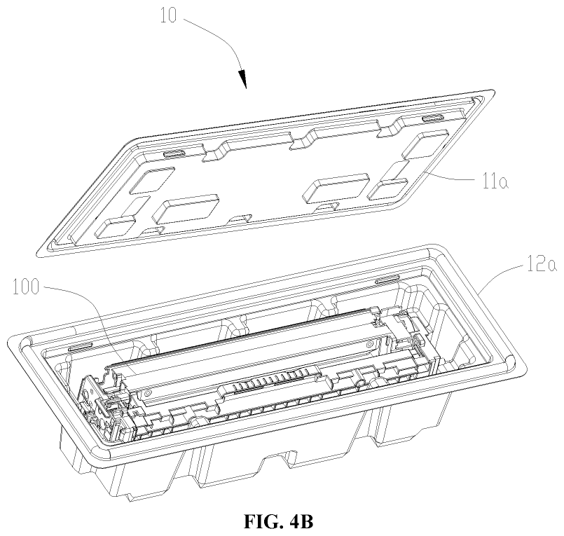

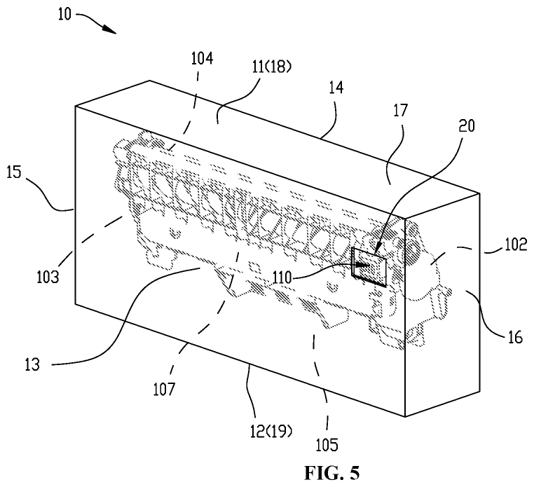

The packaging part in one embodiment is described below. As shown in FIG. 4A to FIG. 5, the packaging part 10 may be a packaging box structure with a fixed external dimension, such as a paper box, a wooden box, an injection molded box body, a plastic uptake box structure or the like and may also be a bag-shaped packaging bag structure without a fixed external dimension. The packaging part 10 may not be limited to a polyhedral structure in terms of spatial structure. For example, when the packaging part is a plastic intake box structure, as shown in FIG. 4B, the packaging part may be a plastic intake product matching the shape of the consumable cartridge. Therefore, the packaging part may generally have surfaces corresponding to all directions of the consumable cartridge in terms of spatial structure, and the packaging form of the plastic intake box may be a half-folded plastic intake box and may be a separate plastic intake box including a bottom part 12a and a lid part 11a. The material of the plastic intake product may include a paper product, PVC, PP and other plastic products, or the like. When using PVC, PP and other plastic products, the plastic intake product may be a formed transparent part, and the thickness of the plastic intake product may not be limited. The structure of the packaging part 10 is described below by taking a hexahedron as an example. According to one embodiment, the packaging part 10 may include a top surface 11, a bottom surface 12, a front surface 13 and a rear surface 14 along the width direction of the packaging part 10, and include a left surface 15 and a right surface 16 along the length direction of the packaging part 10; and these six surfaces may enclose to form a hollow accommodation part 17, and the size and shape of the accommodation part 17 may be suitable for accommodating the developing cartridge 100. In addition, the packaging part 10 may also include an open end 18 for loading the consumable cartridge into the packaging part; the open end 18 may be formed on the top surface 11 of the packaging part 10; and a closed end 19 may be formed on the bottom surface 12 opposite to the top surface 11 correspondingly. The positions of the open end 18 and the closed end 19 may be not limited to being located on the top surface 11 and the bottom surface 12 of the packaging part 10 but may also be located on the left surface 15 and the right surface 16 of the packaging part 10, or the like. The sealing form of the open end 18 may also not be limited, such as sealing through a cover structure or sealing through a transparent sheet covering the open end 18, which may facilitate observation of the internal condition of the packaging part 10. Accordingly, the accommodation part 17 may be formed between the open end 18 and the closed end 19. As shown in FIG. 5, in one embodiment, the developing cartridge 100 may be loaded into the packaging part 10 along the direction from the front end 104 to the rear end 105, so that the rear end 105 of the developing cartridge 100 may correspond to the bottom surface 12 of the packaging part 10, the lower surface 107 of the developer cartridge 100 may correspond to the front surface 13 of the packaging part 10, the left end 103 of the developer cartridge 100 may correspond to the left surface 15 of the packaging part 10, and the right end 102 of the developer cartridge 100 may correspond to the right surface 16 of the packaging part 10. After the developing cartridge 100 is aligned with the structure of the packaging part 10 in the spatial orientation, the developing cartridge 100 may be loaded into the accommodation part 17 from the open end 18 and then the open end 18 may be sealed; that is, the packaging of the developing cartridge 100 by the packaging part 10 may be completed.

According to one embodiment, the packaging part 10 may be further disposed with an operable part 20, and the position of the operable part 20 installed on the packaging part 10 may be not limited. The inside of the packaging part 10 (the accommodation part 17) may be connected to the outside of the packaging part 10 through the operable part 20, such that it may realize that at the outside of the packaging part 10, the consumable cartridge in the accommodation part 17 of the packaging part 10 may be operated through the operable part 20; or it may realize that at the outside of the packaging part 10, the consumable chip of the consumable cartridge in the packaging part 10 may be operated through the operable part 20. The operation through the operable part 20 herein may be the structural processing of the consumable chip on the consumable cartridge or may be above-mentioned data read and write operation. For example, the operable part 20 in one embodiment may be at the front end 13 of the packaging part 10. Optionally, the position of the operable part 20 may correspond to the position of the consumable chip 110 on the developing cartridge 100, and the projection of the consumable cartridge toward the packaging part 10 may be at least partially overlapped with the operable part 20. However, in one embodiment, the operable part 20 may be at the front end 13 adjacent to the left end 15 and directly opposite to the consumable chip 110.

Furthermore, in one embodiment, the structure of the operable part 20 may be an opening structure. The internal structure of the packaging part 10 may be exposed at the opening, so that the accommodation part 17 of the packaging part 10 may be connected with the outside of the packaging part 10. Therefore, at the outside of the packaging part 10, the consumable chip 110 of the consumable cartridge in the packaging part 10 may be operated through the opening. When the data in the consumable chip needs to be read and written, the electrical connection end on the data read and write device (which is provided with electrical connection structures such as contact pins) may be inserted into the opening to form an electrical connection with the chip terminal 111 on the consumable chip 110 of opposite consumable cartridge. Therefore, there is no need to unpack the packaging box. That is, the data stored in the consumable chip 110 may be read and written without opening the seal of the open end 18, which may effectively save time cost, labor cost, and even material cost of reading and writing data, and may be environmentally friendly and avoid unnecessary waste.

### Exemplary Embodiment Two

According to one embodiment, the packaging part may also a packing assembly including a first packaging part and a second packaging part. The first packaging part may be used for accommodating the consumable cartridge, and the second packaging part may be sleeved on the outside of the first packaging part. The first packaging part may be a packaging part inside the whole packaging such as a cotton tray, a paper tray, a bubble bag, a packaging bag or the like; and the second packaging part may be a packaging box structure described in exemplary embodiment one and located at the outermost layer in the whole packaging.

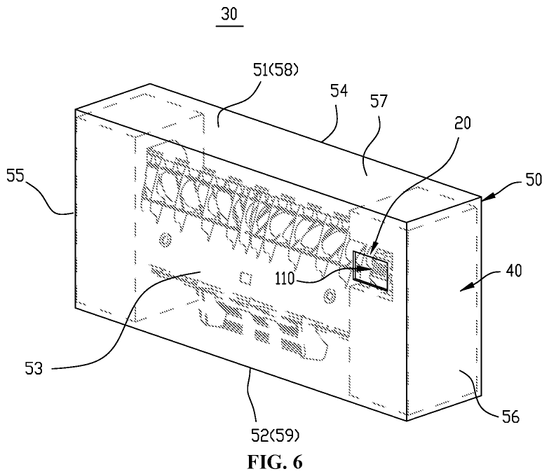

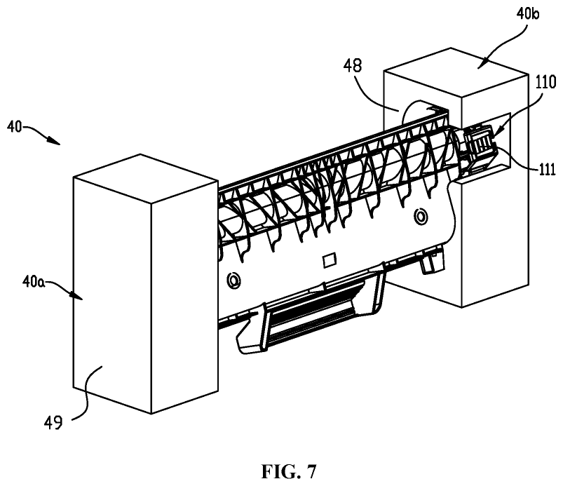

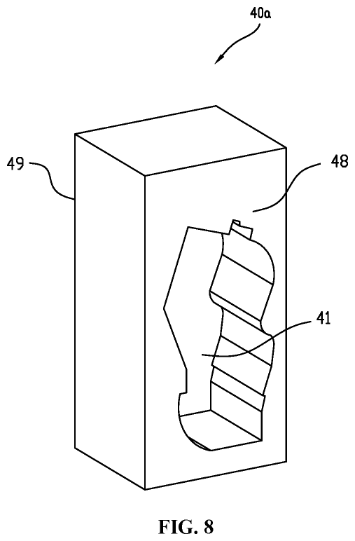

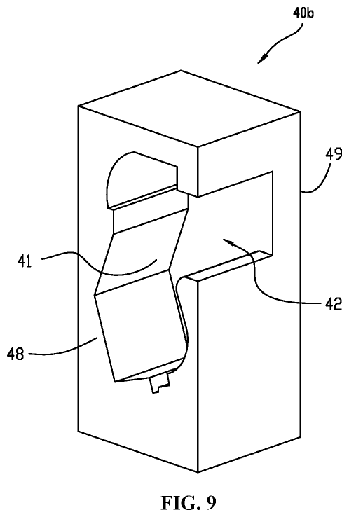

As shown in FIGS. 6-7, the packaging part 30 in one embodiment may include a first packaging part 40 and a second packaging part 50. The second packaging part 50 may be a packaging box structure same as the packaging part 10 in exemplary embodiment one. The second packaging part 50 may include a top surface 51, a bottom surface 52, a front surface 53 and a rear surface 54 along the width direction of the second packaging part 50 and have a left surface 55 and a right surface 56 along the length direction of the second packaging part 50. The second packaging part 50 may include an accommodation part 57, an open end 58 on the top surface 51 and a closed end 59 on the bottom surface 52. The second packaging part 50 may be also disposed with the operable part 20 same as exemplary embodiment one. The inside (e.g., the accommodation part 17 in exemplary embodiment one) of the second packaging part 50 (e.g., the packaging part 10 in exemplary embodiment one) may be connected to the outside of the second packaging part 50 (e.g., the packaging part in exemplary embodiment one) through the operable part 20. The first packaging part 40 may be a cotton tray structure, which may be an inner packaging part made of sponge, pearl cotton, felt and other materials that are closely matched with the consumable cartridge, which may play a role of shock absorption and protection for the consumable cartridge. In one embodiment, the first packaging part 40 may include a left packaging part 40a and a right packaging part 40b with substantially same structures, which are respectively sleeved on both ends of the consumable cartridge along the length direction. As shown in FIGS. 8-9, the left packaging part 40a and the right packaging part 40b may each have an accommodation part 41, an open end 48, and a closed end 49. It should be noted that the closed end 49 may be not an essential structure of the first packaging part 40, and the first packaging part 40 may also be a through-opening structure with both ends open. The accommodation part 41 may be an inner cavity matched with the external structure of the developing cartridge 100. The left end 103 of the developing cartridge 100 may be sleeved in the accommodation part 41 from the open end 48 of the left packaging part 40a; and the right end 102 of the developing cartridge 100 may be sleeved in the accommodation part 41 from the open end 48 of the right packing part 40b, such that tight fit may be completed. In addition, a passing through part 42 may be also disposed on the first packaging part 40. In one embodiment, the passing through part 42 may be disposed on the right packaging part 40b, and the passing through part 42 may be an opening structure for electrically connecting the consumable chip 110 to the outside. Specific position of the passing through part 42 on the right packaging part 40b may match the position of the consumable chip 110 and/or the chip terminal 111 on the developing cartridge 100. After two ends of the developing cartridge 100 are sleeved in the first packaging part 40, the consumable chip 110 and/or the chip terminal 111 of the developing cartridge 100 may be exposed through the passing through part 42; after being further packaged into the second packaging part 50, the consumable chip 110 and/or the chip terminal 111 of the developing cartridge 100 may be electrically connected to the outside of the second packaging part 50 through the passing through part 42 and the operable part 20 of the second packaging part 50; furthermore, it may realize that at the outside of the second packaging part 50, the consumable cartridge in the second packaging part 50 may be operated through the operable part 20; or it may realize that at the outside of the second packaging part 50, the consumable chip 110 of the consumable cartridge in the second packaging part 50 may be operated by the operable part 20. When the data in the consumable chip 110 needs to be read and written, the electrical connection end on the data read and write device (which is provided with electrical connection structures such as contact pins) may be successively inserted into the operable part 20 and the passing through part 42 of the opening structure, thereby forming an electrical connection with the chip terminal 111 on the consumable chip 110 of the consumable cartridge.

### Exemplary Embodiment Three

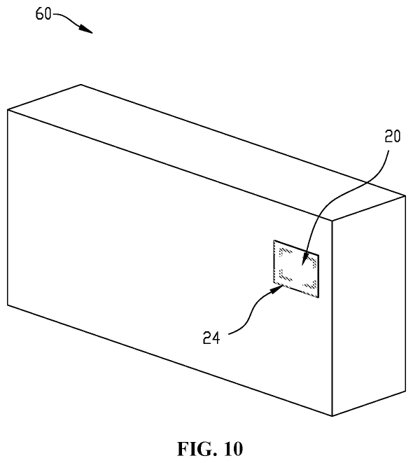

On the basis of above-mentioned embodiments, exemplary embodiment three further provides another structure of the packaging part. A peelable part may be further disposed on the packaging part which is disposed with the operable part; and the peelable part may at least cover the operable part for limiting exposure of the operable part to the outside of the packaging part. As shown in FIG. 10, a packaging part 60 may include the operable part 20 same as exemplary embodiments one and two; and a peelable part 24 may be detachably disposed on the outer surface or the inner surface of the operable part 20. The covering size of the peelable part 24 may be larger than the outer size of the operable part 20. The peelable part 24 may be made of a material including a transparent film, a sticker or the like, and may be covered at the operable part 20 by a manner including sticking, welding and the like, thereby sealing and protecting the packaging part 60. After the peelable part 24 is peeled off from the packaging part 60, the operable part 20 may be exposed. A reminder label may also be printed on the surface of the peelable part 24, which may remind that corresponding read and write operations or other structural operations may be performed on the consumable chip and/or chip terminal inside the packaging part 60 through the operable part 20 which is covered at such position, thereby guiding the user to peel off the peelable part 24.

### Exemplary Embodiment Four

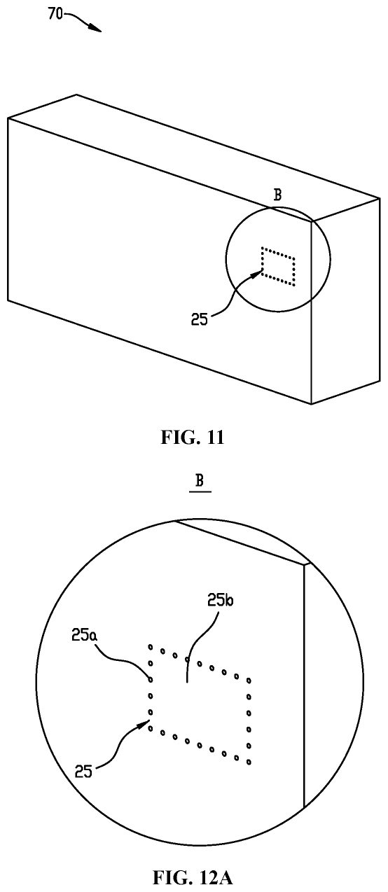

On the basis of above-mentioned embodiments, exemplary embodiment four further provides another structure of the packaging part. As shown in FIG. 11 to FIG. 12B, the packaging part 70 may include a peelable part 25; and the peelable part 25 may be directly peeled off from the packaging part 70 to form the operable part 20 same as exemplary embodiments one and two. For example, as shown in FIG. 12A, the peelable part 25 may include a peeling part 25b and a peeling guide part 25a, and the peeling guide part may be used for detachably connecting the peeling part and the packaging part. In one embodiment, the peeling guide part 25a may be a structure of multiple through holes; and the peeling guide part 25a formed by the multiple through holes may surround the peeling part 25b. As shown in FIG. 12B, when a certain breaking force (such as pressing force) is applied to the peelable part 25b, the through hole structure of the peeling guide part 25a may be broken at the connection of each through hole, such that the peeling of the entire peeling part 25b may be guided by the peeling guide part 25a. An opening structure may be formed on the packaging part 70 after removing the peeling part 25b, that is, the operable part 20 may be exposed. Therefore, the user may perform corresponding operations on the consumable chip and/or chip terminal of the developing cartridge accommodated in the packaging part 70 by breaking the peelable part 25.

### Exemplary Embodiment Five

On the basis of above-mentioned embodiments, exemplary embodiment five further provides a general-purpose packaging part. According to the packaging part in one embodiment, the accommodation part thereof may be used to accommodate consumable cartridges having consumable chips in different positions. The packaging part in one embodiment may have the operable part 20 similar to above-mentioned embodiments. Different from above-mentioned embodiments, the packaging part in one embodiment may include an independent chip packaging structure, and the position of the operable part 20 on the packaging part may be designed at a fixed position; and the position of the chip packaging structure in the packaging part may be configured to correspond to the position of the operable part 20 on the packaging part. Therefore, no matter how the position of the consumable chip of the consumable cartridge to be placed in the packaging part is configured on the cartridge body, the configuration of the position of the operable part 20 on the packaging part may not be affected; and operations such as reading consumable chip and/or chip terminal through the operable part 20 may not be affected.

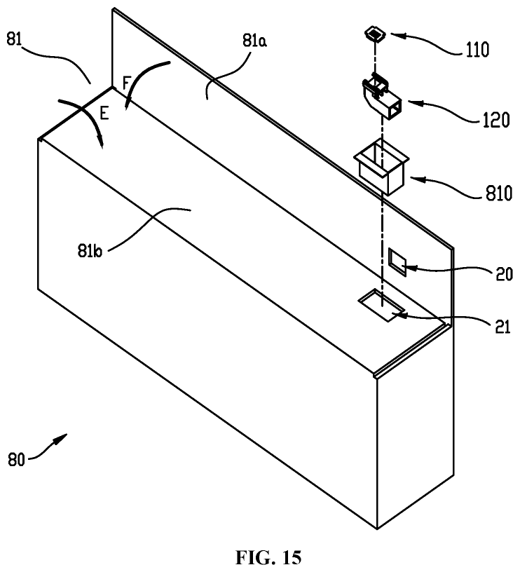

Referring to FIG. 14 and FIG. 15, the packaging manner of the consumable chip 110 in one embodiment is described. The consumable chip 110 with the chip terminal 111 may be installed on the chip holder 120; and the chip holder 120 may be detachably installed on the consumable cartridge (not shown). According to the packaging manner of one embodiment, the chip holder 120 and the consumable cartridge may be packaged into the packaging part 80 after being separated. Therefore, the chip holder 120 may be disposed with a chip packaging part 810 for packaging the consumable chip 110. The packaging manner of the consumable cartridge may be that the consumable cartridge may be installed in the packaging part 80 independently as in above-mentioned embodiments, or the first packaging part such as the cotton tray as in exemplary embodiment two may be installed before the consumable cartridge is installed in the packaging part 80. The chip packaging part 810 may include a housing 811, a hollow accommodation cavity 817 in the housing, and an opening part 818 on the housing that connects the accommodation cavity 817 with the outside of the housing. The consumable chip 110 in the packaging part 80 and in the chip packaging part 810 may be operated from the outside of the packaging part 80 through the opening part 818 and the operable part 20. The accommodation cavity 817 may be used for placing and accommodating the chip holder 120, and the consumable chip 110 and/or the chip terminal 111 may be located at the opening part 818 in the spatial orientation, as shown in exploded schematic orientation of FIG. 15, such that the consumable chip 110 and/or the chip terminal 111 may be exposed in the chip packaging part 810. Furthermore, the chip packaging part 810 may also be disposed with a limiting part 812. When the chip packaging part 810 is installed in the packaging part 80, the limiting part 812 may be abutted against the packaging part 80 to limit the movement of the chip packaging part 810 relative to the packaging part 80, that is, to limit and/or fix the position of the chip packaging part 810, where the form of the limiting part 812 may not be limited. In one embodiment, the chip packaging part 810 may include two limiting parts 812 which are two outer-edge protrusions extending outward from two opposite surfaces of the housing 811 respectively. The two limiting parts 812 may be coplanar with the opening part 818, that is, the two limiting parts 812 and the opening part 818 may be on a same plane, and such structure may facilitate the molding of the chip packaging part 810. It should be noted that the chip holder 120 may be omitted, and the consumable chip 110 may be directly installed in the chip packaging part 810, and the consumable chip 110 and/or the chip terminal 111 may be exposed in the chip packaging part 810.

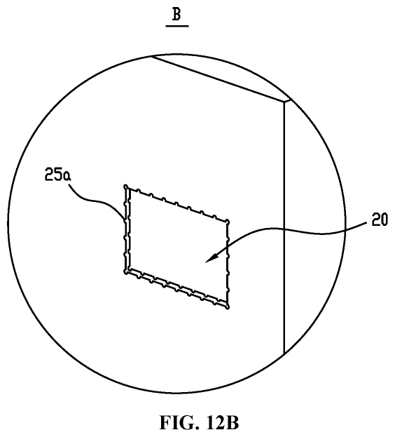

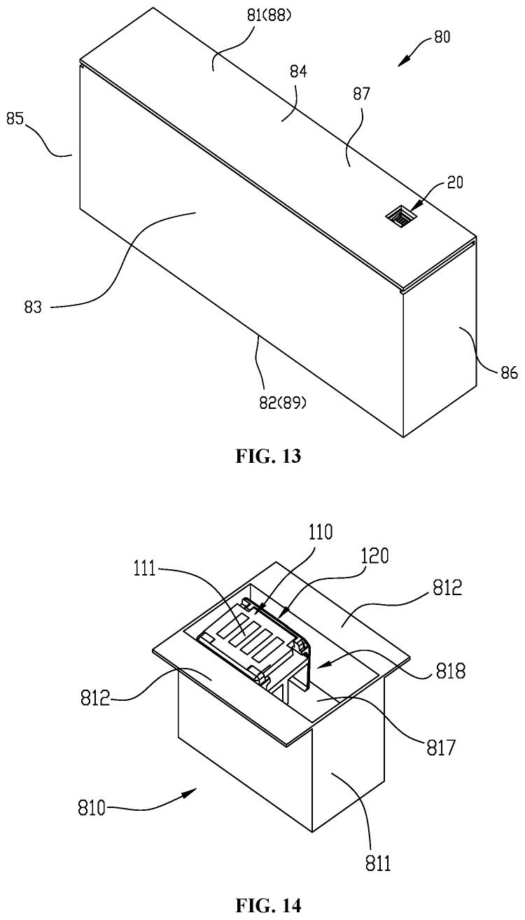

Referring to FIGS. 13, 15 and 16, the structure of the packaging part of one embodiment is described. The packaging part 80 has a top surface 81, a bottom surface 82, a front surface 83 and a rear surface 84 along the width direction of the packaging part 80, and a left surface 85 and a right surface 86 along the length direction of the packaging part 80. These six surfaces may enclose to form a hollow accommodation part 87; an open end 88 may be formed at the top surface 81 of the packaging part 80; and a closed end 89 may be correspondingly formed at the bottom surface 82 opposite to the top surface 81. For example, the top surface 81 may include an outer cover 81a and an inner cover 81b that may be foldable and cover each other. When both the outer cover 81a and the inner cover 81b are opened along the direction toward the outside of the packaging part 80, an opening may be formed at the top surface 81 of the packaging part 80, which may be used for loading the consumable cartridge into the packaging part 80; after the inner cover 81b and the outer cover 81a are folded along the direction toward the inside of the packaging part 80 (directions E and F shown in FIG. 15) respectively, the open end 88 may be closed, thereby completing the packaging of the consumable cartridge. In one embodiment, the operable part 20 may be an opening structure, which is disposed at the top surface 81 of the packaging part 80 and located on the outer cover 81a. For example, the outer cover 81a may be disposed with the operable part 20, and the inner cover 81b may be disposed with a receiving part 21 for accommodating the chip packaging part 810. The operable part 20 and the receiving part 21 may be overlapped with each other. Optionally, the setting area of the receiving part 21 may be greater than or equal to the area of the operable part 20. From the viewpoint of structure simplification, the receiving part 21 in one embodiment may be an opening structure on the inner cover 81b. When the inner cover 81b is folded to be closed along the E direction toward the inside of the packaging part, the receiving part 87 of the packaging part 80 may be connected with the outside of the packaging part 80 through the opening-shaped receiving part 21.

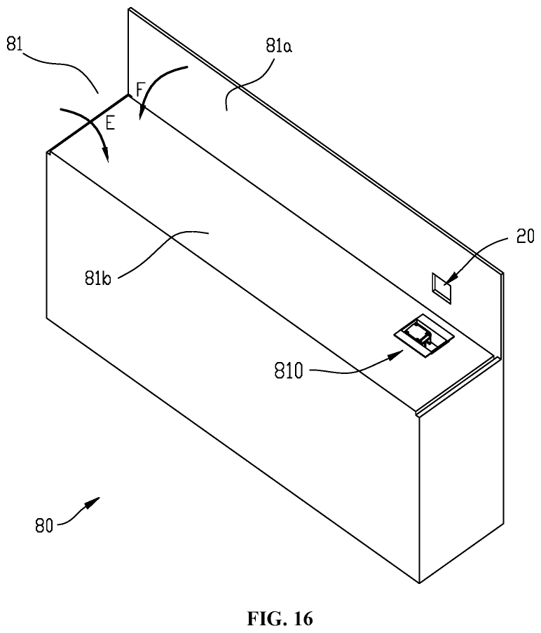

Referring to FIGS. 15-16, the assembly manner of the consumable chip 110, the chip packaging part 810 and the packaging part 80 is described. According to the packaging part 80 in one embodiment, after the consumable cartridge has been loaded into the accommodation part 87 of the packaging part 80, next packaging operation of loading the consumable chip 110 may be performed. The housing 811 of the chip packaging part 810 into which the consumable chip 110 (and the chip holder 120) is loaded may be installed with the receiving part 21, and two limiting parts 812 of the chip packaging part 810 may be adjoined on the peripheral plane of the opening of the receiving part 21, such that the chip packaging part 810 may be installed. Subsequently, as shown in FIG. 16, the outer cover 81a may be folded to be closed along the F direction toward the inside of the packaging part 80, the operable part 20 on the outer cover 81a may be overlapped with the receiving part 21 on the inner cover 81b, and further overlapped with the chip packaging part 810 on the receiving part 21. At this point, the consumable chip 110 and/or chip terminal 111 exposed in the chip packaging part 810 may be further exposed in the packaging part 810 through the operable part 20. In addition, since the area of the operable part 20 is smaller than the setting area of the receiving part 21, the plane on the periphery of the operable part 20 may be abutted against two limiting parts 812 that have been adjoined on the peripheral plane of the opening of the receiving part 21, so that the limiting part 812 may be sandwiched between the inner cover 81b and the outer cover 81a, thereby realizing the fixation of the chip packaging part 810. Subsequently, sealing processing such as gluing or sealing may be further performed on the outer cover 81a of the packaging part 80, that is, the formed structure may be shown in FIG. 13, and the packaging of the consumable cartridge may be completed. Therefore, the consumable chip 110 and/or the chip terminal 111 of the developing cartridge 100 may be connected to the outside of the packaging part 80 through the operable part 20 and the opening part 818. Furthermore, at the outside of the packaging part 80, the consumable chip 110 in the packaging part 80 and in the chip packaging part 810 may be operated by the operable part 20. When the data in the consumable chip 110 needs to be read and written, the electrical connection end on the data read and write device (which is disposed with electrical connection structures such as contact pins) may be inserted into the operable part 20 and the receiving part 21 of the opening structure successively, thereby forming the electrical connection with the chip terminal 111 on the consumable chip 110 of the consumable cartridge. It may be understood that the operable part 20 in one embodiment may also be disposed with a peelable part with a structure different from those in exemplary embodiments three and four, which may not be described in detail herein.

### Exemplary Embodiment Six

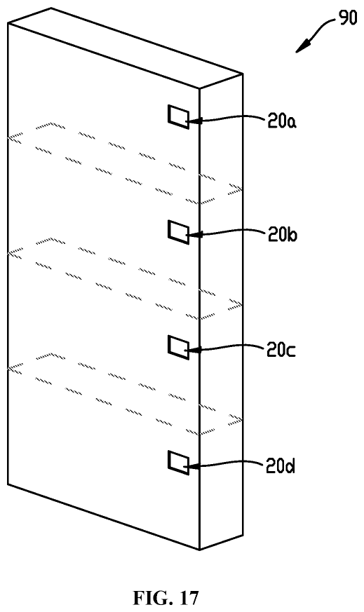

On the basis of above-mentioned embodiments, exemplary embodiment six further provides another structure of the packaging part, which is suitable for combined packaging of consumable cartridges of multiple colors. As shown in FIG. 17, the packaging part 90 may be based on the structure of the packaging part in exemplary embodiments one to five, and the consumable cartridges of four colors may be combined in a same packaging part. Therefore, four operable parts (20a, 20b, 20c and 20d) may be correspondingly disposed on the packaging part 90. The operable parts (20a, 20b, 20c and 20d) in one embodiment may also be same as the structures in above-mentioned embodiments, thereby realizing the read and write operation on the consumable chips of the consumable cartridges of the combined packaging part. It may be noted that, according to the packaging part of the present disclosure, the more complicated the form of the packaging part is, the more convenient the operation such as reading and writing of the consumable chip is.

### Exemplary Embodiment Seven

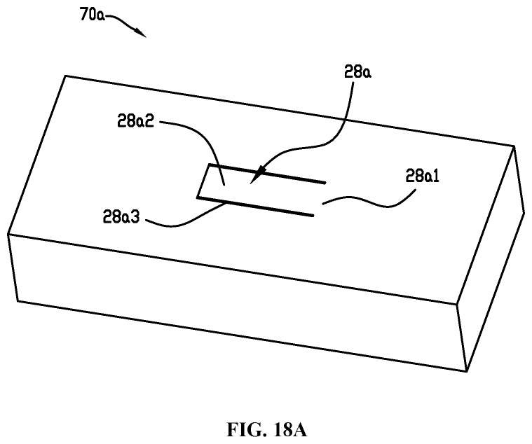

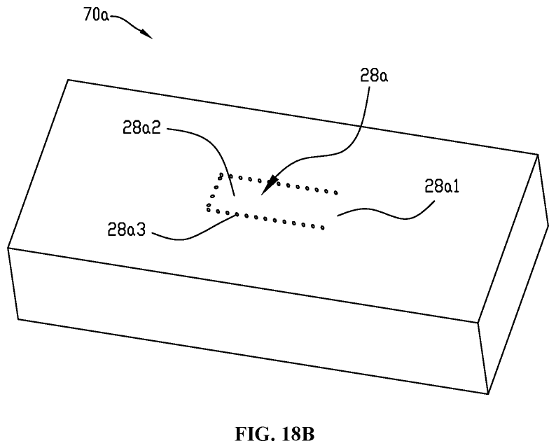

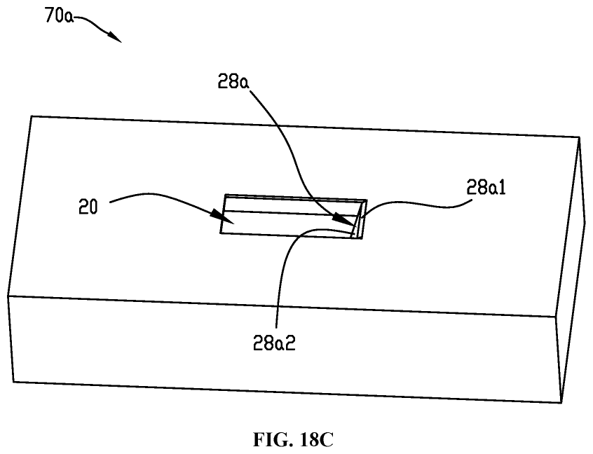

On the basis of exemplary embodiment four, exemplary embodiment seven further provides another structure of the packaging part. As shown in FIGS. 18A-18C, the packaging part 70a may include a peelable part 28a. Different from the peelable part 25 in exemplary embodiment four which may be completely peeled off from the packaging part, the peelable part 28a in one embodiment may be partially peeled off from the packaging part 70a. The peelable part 28a may include a connecting part 28a1, a peeling part 28a2, and a peeling guide part 28a3. The peeling guide part 28a3 may be configured to detachably connect the peeling part 28a2 with the packaging part 70a; and the connecting part 28a1 may connect the peeling part 28a2 with the packaging part 70a. When the peeling guide part 28a3 detaches the peeling part 28a2 from the packaging part 70a, the connecting part 28a1 may limit the peeling part 28a2 from being completely detached from the packaging part 70a. The connecting part 28a1 may be a part of the peelable part 28a which is integrally connected with the packaging part 70a and may not be separated from the packaging part 70a. The peeling guide part 28a3 may use a pre-cut slit structure as shown in FIG. 18A, or a same multiple through-hole structure as the peeling guide part 25a of exemplary embodiment four (as shown in FIG. 18B). Similarly, after peeling the peeling part 28a2 of the peelable part 28a, the operable part 20 of exemplary embodiments one and two may be directly formed. As shown in FIG. 18C, when a certain breaking force (such as pressing force) is applied to the peelable part 28a, taking the connecting part 28a1 as the base line, the peeling guide part 28a3 may be folded into the packaging part along the slit structure or through-hole structure thereof, such that the peeling of the peeling part 28a2 may be guided by the peeling guide part 28a3. After the peeling part 28a2 is separated from the packaging part 70a, an opening structure may be formed on the packaging part 70a, that is, the operable part 20 may be exposed.

### Exemplary Embodiment Eight

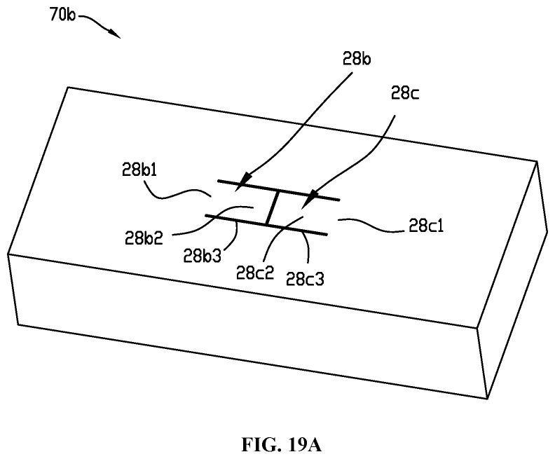

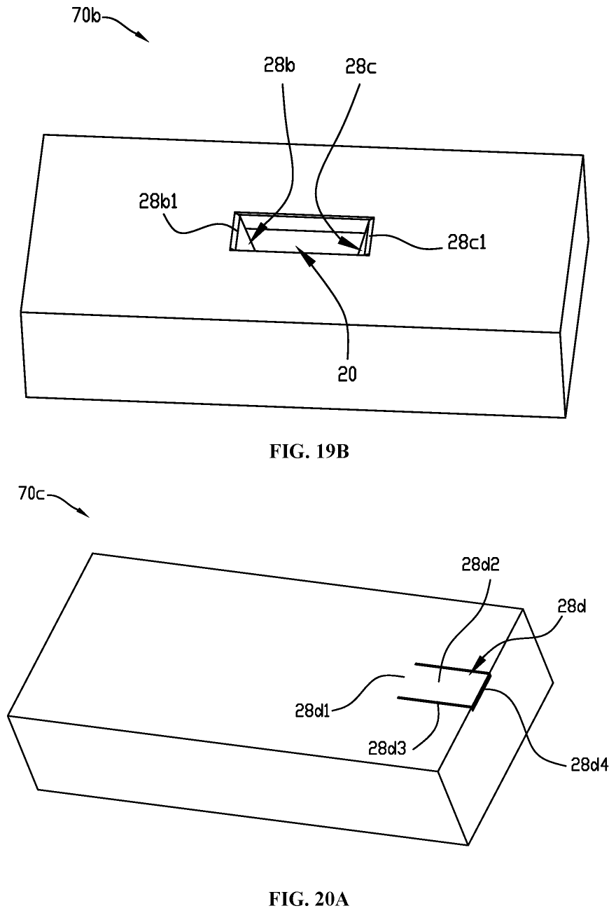

On the basis of exemplary embodiment seven, exemplary embodiment eight further provides another structure of the packaging part. The peeling part may include a first peeling part and a second peeling part, and the connecting part may include a first connecting part and a second connecting part; the first peeling part may be integrally formed with the packaging part through the first connecting part, and the second peeling part may be integrally formed with the packaging part through the second connecting part; the first peeling part and the second peeling part may be detachably connected by the peeling guide part; the first peeling part and the packaging part may be detachably connected by the peeling guide part; and the second peeling part and the packaging part may be detachably connected by the peeling guide part. For example, as shown in FIGS. 19A-19B, the packaging part 70b may include a first peelable part 28b and a second peelable part 28c; and the first peelable part 28b and the second peelable part 28c may be disposed on the packaging part 70b in opposite directions. For example, the first peelable part 28b may include a first connecting part 28b1, a first peeling part 28b2 and a first peeling guide part 28b3; and the second peelable part 28c may include a second connecting part 28c1, a second peeling part 28c2, and a second peeling guide part 28c3. In one embodiment, the first peelable part 28b and the second peelable part 28c may be arranged in parallel; and the first connecting part 28b1 and the second connecting part 28c1 may be respectively provided at two ends of the first peelable part 28b and the second peelable part 28c as a whole, so that the first peelable part 28b and the second peelable part 28c may be peeled in opposite directions, which may not be limited in the present disclosure. The first peelable part 28b and the second peelable part 28c may also be peeled in non-opposite directions. The first peeling guide part 28b3 and the second peeling guide part 28c3 may be a connected slit structure (may also be through-hole structure). As shown in FIG. 19B, when a certain breaking force (such as pressing force) is applied to the first peelable part 28b and the second peelable part 28c, the first peelable part 28b and the second peelable part 28c may respectively use the first connecting part 28b1 and the second connecting part 28c1 as a base line, and the first peeling guide part 28b3 and the second peeling guide part 28c3 may be respectively folded into the packaging part 70b along the slit structure or through-hole structure thereof. Therefore, the peeling of the first peeling part 28b2 may be guided by the first peeling guide part 28b3, the peeling of the second peeling part 28c2 may be guided by the second peeling guide part 28c3, and after the first peeling part 28b2 and the second peeling part 28c2 are separated from the packaging part 70b, an opening structure may be formed on the packaging part 70b, that is, the operable part 20 may be exposed.

Compared with exemplary embodiment seven, in the case of obtaining the operable part 20 of a same size, disposing two peelable parts may reduce the unilateral inward folding length, that is, shorten the length of the peeling part 28a2 in exemplary embodiment seven. In such way, unnecessary interference may be prevented due to excessively long peeling part 28a2 folded into the packaging part to be abutted against the consumable cartridge or the consumable chip in the packaging part, and the vision field may be also wider.

### Exemplary Embodiment Nine

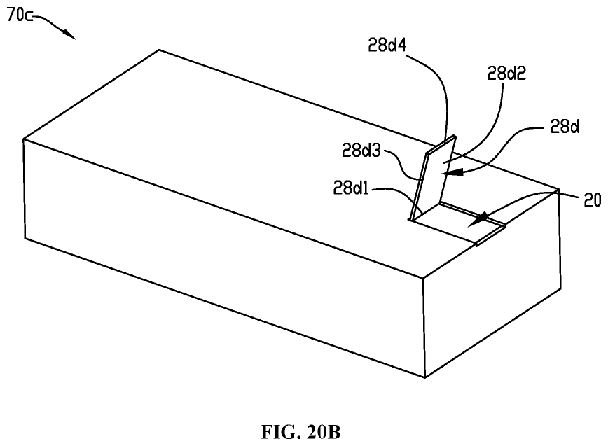

On the basis of exemplary embodiment seven, exemplary embodiment nine further provides another structure of the packaging part. As shown in FIGS. 20A and 20C, the packaging part 70c may include a peelable part 28d. Different from the peelable part 28a in exemplary embodiment seven which may be folded to be peeled inwardly on the packaging part 70a, the peelable part 28d in one embodiment may be folded to be peeled outwardly on the packaging part 70c. For example, the peelable part 28d may include a connecting part 28d1, a peeling part 28d2, and a peeling guide part 28d3, and the functions of all parts may be same as those in exemplary embodiment seven. As shown in FIG. 20C, after the peeling part 28d2 is separated from the packaging part 70c, an opening structure may be formed on the packaging part 70c, that is, the operable part 20 may be exposed, which may not be described in detail herein. Furthermore, the peeling guide part 28d3 may include a peeling-start part 28d4. The peeling-start part 28d4 may be formed on the peeling part 28d2 at the side away from the connecting part and used for starting to peel the peelable part 28d (i.e., start to peel the peeling guide part 28d3 to disconnect the peeling part 28d2 from the packaging part 70c). In one embodiment, the peeling-start part 28d4 may be at the corner of the outer edge of the packaging part, which may be convenient for the user to open the peelable part 28d to the outside of the packaging part by hand. The peeling-start part 28d4 may also be a structure such as a raised piece of paper to function as a handle. Such structure may be more convenient when the peelable part 28d is disposed at a non-edge position such as the middle of the plane of the packaging part.

In addition, two peelable parts 28d may also be disposed in a manner similar to the opposite direction manner in exemplary embodiment eight, which may not be described in detail herein.

### Exemplary Embodiment Ten

On the basis of above-mentioned embodiments, exemplary embodiment ten further provides another structure of the packaging part. An identification part may also be disposed on the outer surface of the packaging part. When the electrical connection structures such as contact pins in the electrical connection end on the data read and write device have a corresponding arrangement relationship with the chip terminals of the consumable chip in the packaging part, for example, multiple contact pins are in one-to-one contact with multiple chip terminals to form electrical connection, the arrangement of multiple contact pins on the electrical connection end and the arrangement of multiple chip terminals on the consumable chip may have sequential requirements, respectively. Therefore, there are directional requirements for overall corresponding operation of the electrical connection end of the data read and write device and the consumable chip. The identification part may be identified, so that the electrical connection between the data storage part and the external data read and write device may be accurate. That is, the identification part may be used for orientation calibration between the packaging part and the data read and write device, which may prevent reverse connection between the electrical connection end on the data read and write device and the chip terminals due to reversed orientation of the packaging part during batch operations, thereby ensuring direct and accurate read and write operations. Therefore, there is no need for tedious operation of adjusting the direction of the packaging part or the data read and write device after it's found that the electrical connection end and the chip terminal are reversely connected.

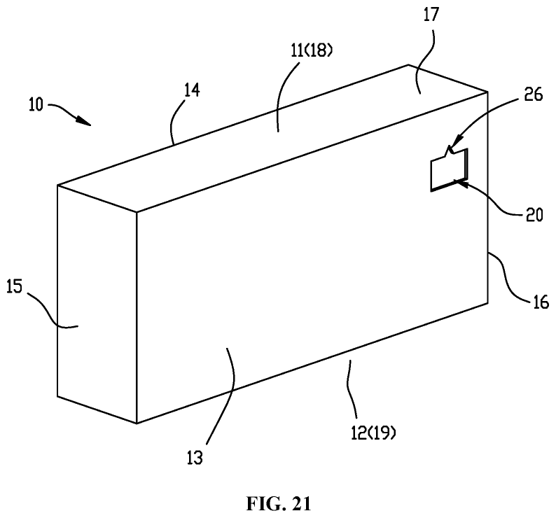

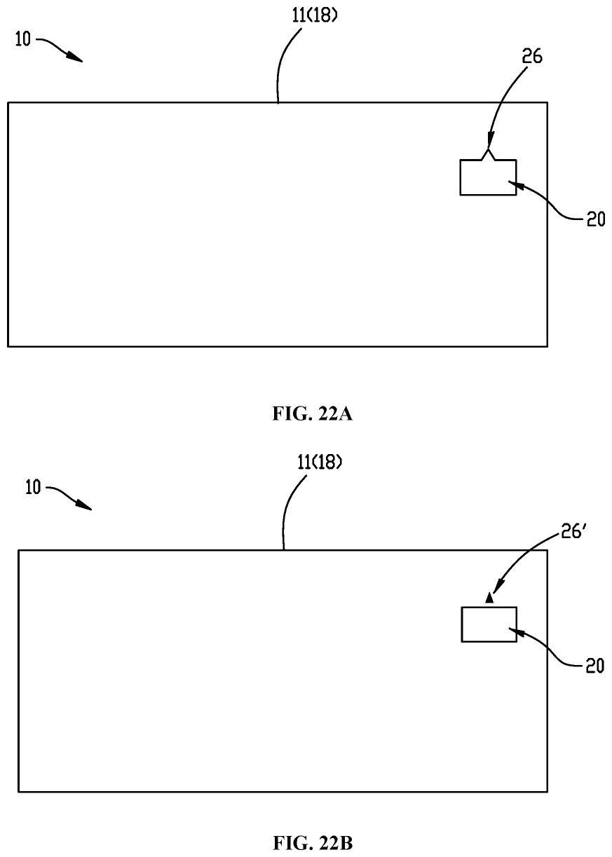

The structure of exemplary embodiment one is taken as an example for description below. As shown in FIG. 21, an identification part 26 may be added on the basis of the structure of the packaging part 10. The position of the identification part 26 may be not particularly limited but may be optionally located around the operable part 20. In one embodiment, the identification part 26 may be disposed at the position of the operable part 20 adjacent to the top surface 11, that is, above the operable part 20. The structure and shape of the identification part 26 may be the identification opening structure as shown in FIG. 22A and may be a directional shape such as a triangle or other special shape. The identification part 26 may be integrally cut and shaped with the operable part 20 or may be cut and shaped separately. In addition, the identification part may also be configured as the identification part 26′ as shown in FIG. 22B. Structures, which may be scanned and identified, such as triangles, arrows, or other patterns, may be formed on the packaging part 10 by means of printing or the like.

In one embodiment, the orientation calibration function of the identification part 26 may be realized by photographing/scanning operation of the packaging part.

Furthermore, exemplary embodiment ten also provides a method for reading and writing a chip in a packaged consumable cartridge (packaging assembly), which is realized by following exemplary steps.

The packaging assembly may be placed on the operating table.

The position of the packaged assembly may be identified, and according to the identification result, it may determine whether adjusting the placement position of the packaging assembly relative to the operating table and/or the position relative to the data read and write device is needed.

The data storage part and the data read and write device may be electrically connected through the operable part.

For example, on the operating table, the packaging assembly may include a preset placement position, so that the data storage part and the data read and write device may be electrically connected with each other.

For identifying the position of the packaging assembly, when it is identified that the packaging assembly is placed in the preset placement position, the identification result may be “Yes”; and when it is identified that the packaging assembly is not placed in the preset placement position, the identification result may be “No”.

For example, when the identification result is “yes”, the data storage part may be electrically connected with the data read and write device; and when the identification result is “No”, the position of the operating table and/or the packaging assembly may be adjusted until the identification result is “Yes”, or the position of the data read and write device may be adjusted until the identification result is “Yes”.

More detailed exemplary operation steps may be as described as the following.

(1) The Packaging Part (Packaging Assembly) at Least Packaged with the Consumable Chip May be Placed on the Operating Table for Chip Read and Write Operations.

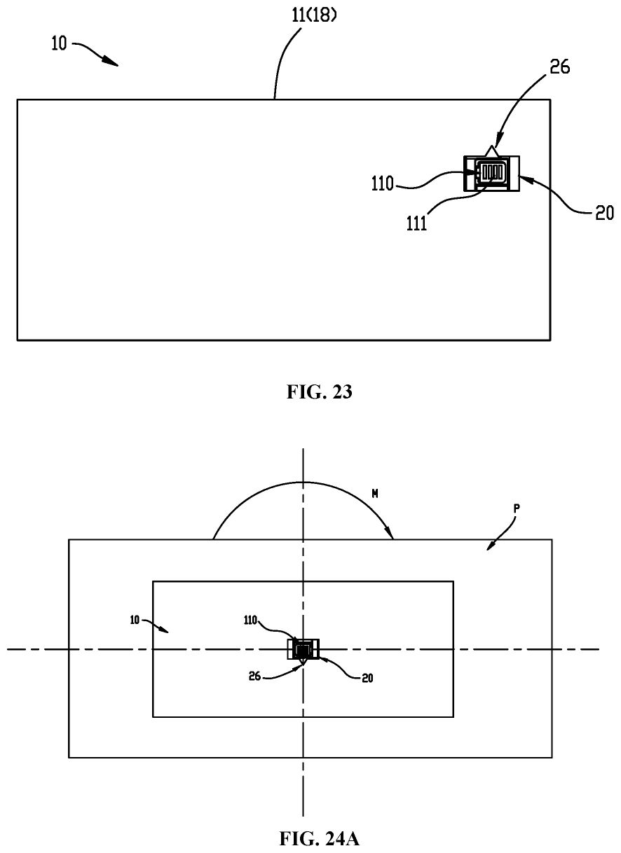

As shown in FIG. 23, after the developing cartridge 100 is packaged by the packaging part 10, the chip 110 and/or the chip terminal 111 may be exposed at the operable part 20. The packaging part 10 packaging the developing cartridge 100 may be that the packaging part 10 may directly accommodate the developing cartridge 100 as in exemplary embodiment one and may also be that the developing cartridge 100 may be packaged by the packaging assembly such as the packaging part 30 in exemplary embodiment two, which may not be limited herein. At least packaged with the consumable chip may indicate that the consumable chip and the consumable cartridge may be packaged separately and independently, for example, the consumable chip and the consumable cartridge may be packaged separately and independently based on exemplary embodiment five.

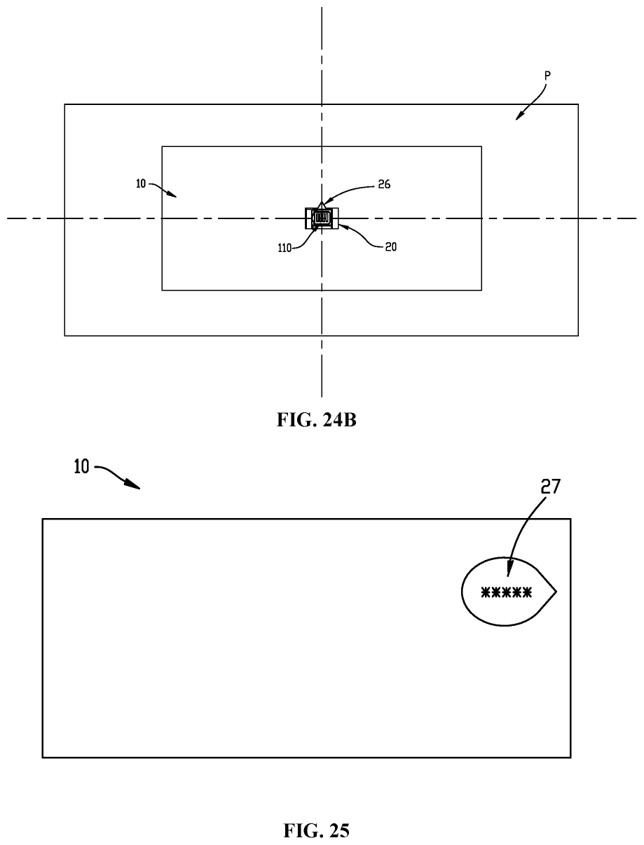

Taking the packaging part 10 in exemplary embodiment one as an example hereinafter, as shown in FIG. 24A and FIG. 24B, the packaging part 10 (packaging assembly) packaged with the consumable chip may be placed on the operating table P for chip read and write operations. The operating table P may be a table surface that can rotate around its rotation axis (not shown). The rotation action of the operating table P may be controlled automatically or manually, which may not be limited herein. The placement position of the packaging part 10 on the operating table may be through a manner including manual control or designing an alignment structure on the operating table, so that the packaging part 10 may be firmly engaged on the operating table P, and the packaging part 10 may be ensured to maintain the standard position (alignment position) in the operating table P. During subsequent read and write operations, especially in the case of batch operations on a plurality of packaging parts 10 at least packaged with consumable chips, it may be beneficial for the alignment of the data read-write device with the consumable chip 110 in the packaging parts 10. In one embodiment, the standard position may be that after the packaging part 10 is placed on the operating table P, the side of the packaging part 10 with the operable part 20 may face upward relative to the plane where the operation table P is located, and the direction in which the consumable chip 110 located in the packaging part 10 may be basically aligned with the electrical connection end of the data read and write device. When the chip terminals 111 of the chip 110 and the electrical connection end of the data read and write device have orientation requirements, the standard position may also include the arrangement manner of the packaging part 10 which may achieve correct arrangement order of the chip terminals 111.

(2) The Packaging Part May be Photographed and Scanned.

The above-mentioned data read and write device may have the function of photographing/scanning or may be attached with photographing/scanning device which may be used in conjunction with the data read and write device. Before the data read and write device reads and writes the chip, the packaging part placed on the operating table P may be photographed or scanned by the data read and write device or the photographing/scanning device at the operable part to obtain the picture at the operable part for next operations. For example, the picture at the operable part may include the identification part around the operable part.

(3) Identification Operation May be Performed to Obtain Identification Result.

According to the picture obtained by photographing or scanning in step (2), it may identify whether the position (including the direction) of the packaging part placed on the operating table P is correct, that is, whether the packaging part is in a preset placement position. The identification operation in this step may be performed electronically through electronic processing device or the like or may be manually identified through manual observation or the like. In one embodiment, the correct position (preset placement position) of the packaging part may indicate that the identification part 26 is located in the correct position. At this point, it may indicate that overall correspondence between the electrical connection end of the data read and write device and the consumable chip in the packaging part may be consistent, thereby ensuring that the arrangement of multiple contact pins on the electrical connection end and the arrangement of multiple chip terminals on the consumable chip may correspond correctly. In such way, subsequent data read and write operations may not fail. For example, the correct position of above-mentioned identification part 26 is that the identification part 26 may be above the operable part 20 in the obtained picture facing the operable part 20; if the identification part 26 is in another position of the operable part 20 (the left side, the right side, or the lower part of the operable part 20) in the obtained picture, it may be a wrong position, that is, the packaging part may be placed in the wrong position. The information on the correct position of the identification part may be configured in the electronic processing device in advance or may be specified manually. The information of the correct position may also be flexibly specified according to different needs. For example, it may configure the identification part 26 below the operable part 20 in the obtained picture to be the correct position and the identification part 26 at other position of the operable part 20 (the left side, the right side, or the upper side of the operable part 20) to be the wrong position, which may not be limited herein. Therefore, the orientation alignment function of the identification part 26 may be realized.

(4) Command May be Outputted According to the Identification Result.

When the identification operation result (identification result) obtained in step (3) is that the identification part 26 is detected to be in the correct position (preset placement position), the next step may be directly performed. When the identification result is that the identification part 26 is detected to be in the wrong position, the orientation of the data read and write device or the orientation of the packaging part and/or the operating table P may be adjusted to realize position correction. For example, adjusting the placement position of the packaging assembly relative to the operating table may be to rotate and/or move one of the operating table and the packaging assembly. Adjusting the position of the packaging assembly relative to the data read and write device may be to rotate and/or move the data read and write device. Considering the ease of operation, it is preferable to adjust the orientation of the data read and write device (rotate and/or move the data read and write device). At this point, the electrical connection end of the data read and write device may be clamped and controlled by the automatic device. For example, the electrical connection end of the data read and write device may be controlled to rotate. Therefore, the arrangement order of the contact pin(s) therein may satisfy the arrangement order of the chip terminal(s) in the packaging part. At this point, next step may be performed.

When the orientation of the packaging part and/or the operating table P is adjusted to achieve position correction, it is preferable to directly rotate the operating table P to perform adjustment, so that the identification part 26 may be in the correct position in the picture being photographed/scanned. As shown in FIG. 24A, the position of the packaging part is wrong initially, and the identification part 26 may be below the operable part 20. After identifying the result, the operating table P may be rotated 180 degrees along the arrow M, so that the operating table P and the packaging part on the operating table may be positioned as shown in FIG. 24B. At this point, it may re-identify that the identification part 26 is in the correct position in the picture being photographed/scanned, and the next step may be performed. In particular, when the rotation action of the operating table P is automatically controlled, the adjustment operation may be more efficient. As shown in FIGS. 24A and 24B, the operable part 20 and the identification part 26 may be mirror-symmetrically arranged on the packaging part, which are in the intermediate part of the plane. When the operable part 20 and the identification part 26 are not mirror-symmetrically arranged on the packaging part, for example, disposed at one end of the plane where the operable part 20 and the identification part 26 are located (as shown in FIG. 21), after the operating table P is rotated 180 degrees along the arrow M, the operable part 20 and the identification part 26 in the picture which is photographed/scanned again may be at the other end of the plane where the operable part 20 and the identification part 26 are located. At this point, the position of the data read and write device may be moved to the other end.

Furthermore, when step (3) is manual identification, the determination of the identification result in this step and the orientation adjustment of the data read and write device, or the orientation adjustment of the packaging part and/or the operating table P, and/or next operations may be performed manually. When step (3) is electronic identification, the identification result in this step may be prompted by sound, light and the like. Therefore, subsequent orientation adjustment of the data read and write device, the orientation adjustment of the packaging part and/or the operating table P, and next operations may be automated through manual or related electronic and electronic control device. An error may not be reported, but the orientation of the data read and write device may be directly and automatically adjusted after the wrong position is found, or the orientation of the packaging part and/or the operating table P may be adjusted, and the next step may be proceeded subsequently, thereby improving working efficiency.

(5) Chip Read and Write Operation

When step (4) is completed and the next step is performed, it may indicate that the electrical connection end of the data read and write device and the consumable chip in the packaging part have reached an alignment state. Through manual or automatic operation, the electrical connection end of the data read and write device may be in contact with the consumable chip in the packaging part, such that the contact pin(s) and the chip terminal(s) (one-to-one correspondence) may be correspondingly contacted to form electrical connection, thereby performing read and write operations on the consumable chip.

In addition, above steps (1) and (2) may also be replaced with that the orientation calibration function of the identification part 26 may be achieved by a structure manner. For example, a certain protrusion structure on the data read and write device may be used to be matched with the structure of the opening-shaped identification part 26. When the data read and write device is inserted into the operable part 20 of the packaging part to perform chip reading and writing, the opening structure of the identification part 26 may accommodate the protrusion structure on the data read and write device, such that the electrical connection end of the data read and write device may be smoothly inserted into the operable part 20 and contact the chip terminal correctly to form electrical connection. If the packaging part is not placed in the correct position, the protrusion structure on the data read and write device may interfere with the periphery of the operable part 20, which may prevent the electrical connection end of the data read and write device from inserting into the operable part 20, such that further contact with the chip terminal may not be performed, and the wrong contact between the electrical connection end and the chip terminal may be prevented.

### Exemplary Embodiment Eleven

As shown in FIG. 25, on the basis of above-mentioned embodiments, a plastic film (not shown) may be disposed on the outermost surface of the packaging part, and a covering part 27 may be added outside the plastic film. The position of the covering part 27 on the packaging part may correspond to corresponding position of the operable part on the packaging part, that is, the covering part 27 may cover the plastic film at the position of the operable part. According to the structure of one embodiment, the plastic film may be disposed on the outermost surface of the packaging part, which may satisfy the supply requirements of specific customers. That is, after packaging the consumable chip and the consumable cartridge without data reading and writing, the plastic film may be disposed for sealing to prevent water vapor and pollutants from entering the packaging part through the operable part 20. When the data is read and written, the plastic film on the surface of the operable part 20 may only need to be broken, and an operation hole may be formed on the plastic film; and after the data read and write operation is completed, a covering part may be attached to the operation hole on the plastic film, and the complete and sealed packaging part may be re-formed. The covering par may be a label, and publicity information or graphic information including the performance and quality of the consumable cartridge in the packaging part may be printed on the label.

When the chip reading and writing operation is performed in step (5) in exemplary embodiment ten, the electrical connection end of the data read and write device may be in contact with the consumable chip in the packaging part through manual or automatic operation. This operation process may be to directly break the plastic film on the surface of the operable part 20 by using the data read and write device, such that the operable part 20 may be inserted and in correct contact with the chip terminals correspondingly to form electrical connection and the operation hole may be formed on the plastic film; or the plastic film on the surface of the operable part 20 may also be broken in advance to form the operation hole, which may avoid adverse effect of the plastic film on the reaction force of the data read and write device, especially the electrical connection end. In particular, this design and operation is especially applicable when the packaging is in the form of the plastic intake box, especially when the plastic intake box is made of a plastic material. Placing the plastic film on the plastic intake box and directly breaking the plastic film on the surface of the operable part 20 with the data read and write device may be more reasonable and desirable for the design and production of the plastic intake box.

When the data reading and writing operation is completed, after step (5) in exemplary embodiment ten, the operation of setting the covering part in step (6) may be added; and after the data read and write device is removed from the packaging part, the operation hole may be form in the plastic film on the surface of the operable part 20. At this point, a labeling part may be used as a covering part to cover the operation hole, and a complete and sealed packaging part may be formed.

In above-mentioned exemplary embodiments one to eleven, for disposed operable part, the opening structure disposed on the packaging part is taken as an example for corresponding description or extended to other embodiments for corresponding expansion. However, disposed operable part may not be limited to the structural matching form of the opening, which may be adjusted according to different types of parts to-be-packaged inside the packaging parts or different usage environments, correspondingly. When the part to-be-packaged is a developing cartridge or an ink cartridge, the operable part disposed may be different from above-mentioned embodiments. The following takes another packaging part formed by setting the operable part as an electrical contact part in the form of structural cooperation as an example for description.

### Exemplary Embodiment Twelve

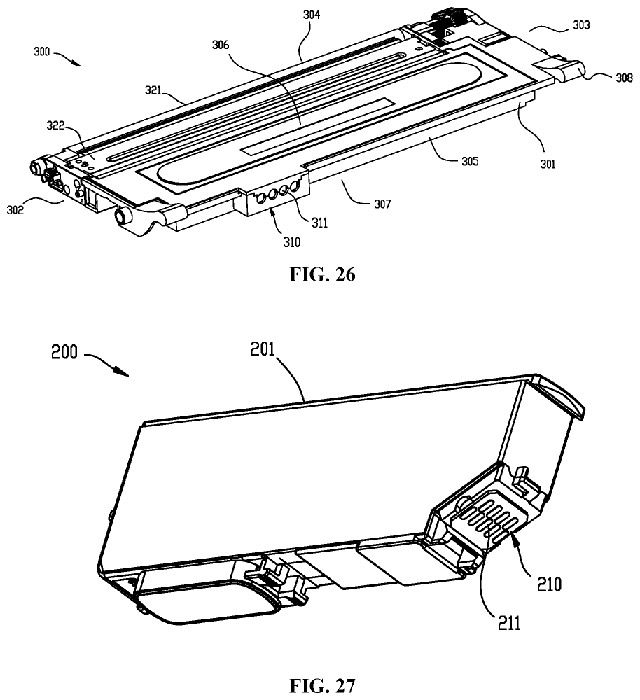

As shown in FIGS. 26-30, exemplary embodiment twelve provides another packaging part that may be used for packaging the consumables cartridge (such as the developing cartridge 300 or the ink cartridge 200). The developing cartridge 300 may be detachably installed on the main body of the laser printer and include a cartridge body 301 and a consumable chip 310 on the cartridge body 301; and at least one chip terminal 311 may be disposed on the consumable chip 310.

The ink cartridge 200 may be detachably installed on the main body of the inkjet printer and include a cartridge body 201 and a consumables chip 210 on the cartridge body 201; and at least one chip terminal 211 may be disposed on the consumables chip 210.

Taking the consumable chip 310 as an example, the consumable chip 310 may store data which can be read and written. For example, a memory (not shown) may be included in the consumable chip 310, and the print information data related to the consumable cartridge may be stored in the memory. The chip terminal 311 may be electrically connected to the memory. After the chip terminal 311 is powered on, the data in the memory may be read and written; and the read and write may include operations such as rewriting, rewriting, upgrading, resetting and the like.

The packaging part of one embodiment is described below by taking the developing cartridge 300 as an example. As shown in FIG. 26, along the length direction of the developing cartridge 300, its two ends may respectively be a conductive end 302 disposed with a conductive part and a driving end 303 disposed with a transmission mechanism such as a gear; along the width direction of the developing cartridge 300, the developing cartridge 300 may include a front end 304 and a rear end 305; and along the height direction of the developing cartridge 300, the developing cartridge 300 may include an upper surface 306 and a lower surface 307. The front end 304 of the developing cartridge 300 may be disposed with components such as a developing roller 321, a developer regulating blade 322 and the like. The rear end 305 of the developing cartridge 300 may be disposed with a handle 308.

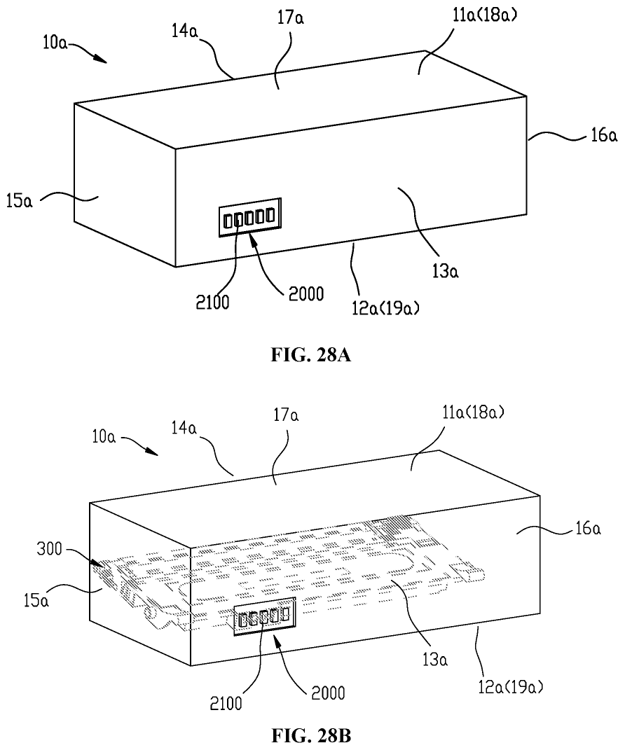

As shown in FIGS. 28A-30, a packaging part 10a may be a box structure with a fixed external dimension, such as a paper box, a wooden box, an injection molded box structure, or the like. The spatial structure of the packaging part 10a may not be limited to the structure of a polyhedron. Specific structure of the packaging part 10a is described below by taking a hexahedron as an example. For example, the packaging part 10a may include a top surface 11a, a bottom surface 12a, a front surface 13a and a rear surface 14a along the width direction of the packaging part 10a and include a left surface 15a and a right surface 16a along the length direction of the packaging part 10a. The six surfaces may enclose to form a hollow accommodation part 17a; and the size and shape of the accommodation part 17a may be suitable for accommodating the developing cartridge 300. In addition, the packaging part 10a may also include an open end 18a for loading the consumable cartridge into the packaging part. The open end 18a may be disposed on the top surface 11a of the packaging part 10a, and the bottom surface 12a opposite to the top surface 11a may be correspondingly formed with a closed end 19a. The positions of the open end 18a and the closed end 19a may not be limited to being located on the top surface 11a and the bottom surface 12a of the packaging part 10a but may also be located on the left surface 15a and the right surface 16a of the packaging part 10a and the like. The sealing form of the open end 18a may also not be limited. For example, the open end 18a may be sealed by a cover structure, or a transparent sheet may cover and seal the open end 18a to facilitate the observation of the internal condition of the packaging part 10a. Accordingly, the accommodation part 17a may be formed between the open end 12a and the closed end 13a. As shown in FIG. 28B, after the developing cartridge 300 is aligned with the structure of the packaging part 10a in the spatial orientation, the developing cartridge 300 may be loaded into the accommodation part 17a from the open end 18a, and then the open end 18a may be sealed, such that the packaging of the developing cartridge 300 by the packaging part 10a may be completed.

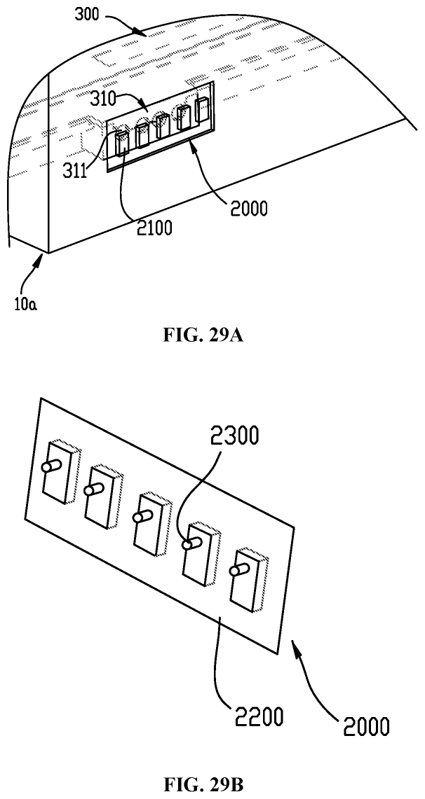

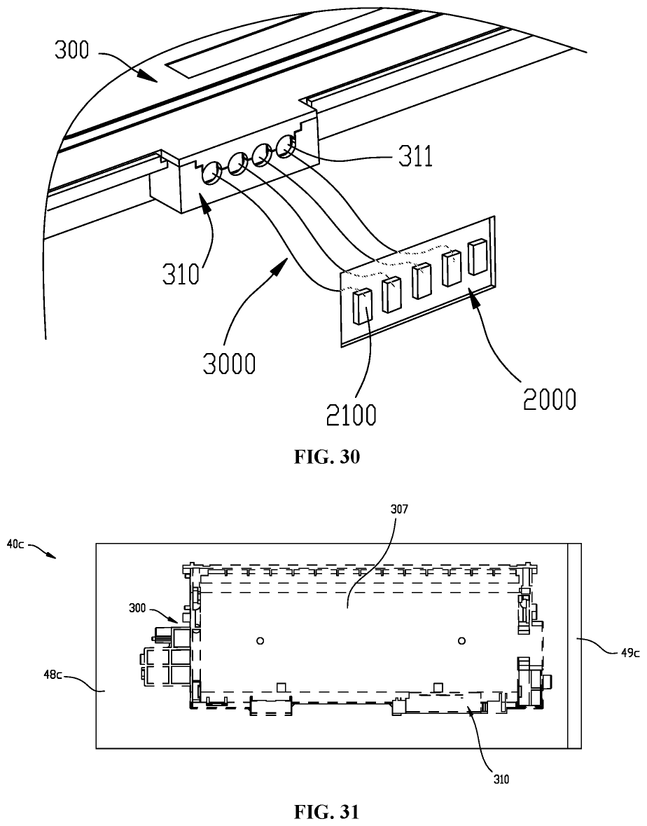

According to one embodiment, an electrical contact part 2000 may be further disposed on the packaging part 10a, and the electrical contact part 2000 may be used for electrical connection with the consumable chip 310. As shown in FIG. 28A, the electrical contact part 2000 may be installed on the packaging part 10a and exposed in the packaging part 10a. The position of the electrical contact part 2000 installed on the packaging part 10a may not be limited. Optionally, the position of the electrical contact part 2000 in one embodiment may correspond to the position of the chip 310 on the developing cartridge 300. For example, the electrical contact part 2000 may be at the front end 13a and adjacent to the left end 15a and exposed in the front end 13a. As shown in FIGS. 28A, 28B and 29A, the electrical contact part 2000 may include at least one external terminal 2100. At least one external terminal 2100 may be used for correspondingly contacting and forming electrical connection with at least one chip terminal 311 on the consumable chip 310, respectively. After the external terminal 2100 is connected to the data read and write device, the data read and write device may perform read and write operation on the consumable chip 310 by being electrically connected to the external terminal 2100. In other words, when the electrical contact part 2000 forms electrical connection with the consumable chip 310, data in the memory of the consumable chip 310 may be read and written through the electrical contact part 2000. For example, corresponding contact between the external terminal 2100 and the chip terminal 311 may be a direct contact as shown in FIG. 29A or an indirect contact as shown in FIG. 30.

When corresponding contact between the external terminal 2100 and the chip terminal 311 is direct contact, as shown in FIG. 29A, after the developing cartridge 300 is loaded into the accommodation part 17a from the open end 18a, and in the case that the structural dimensions of the developing cartridge 300 and the accommodation part 17a are designed to be matched, the consumable chip 310 on the developing cartridge 300 may be directly aligned and in contact with the rear side of the electrical contact part 2000 on the packaging part 10a. Furthermore, the structure of the rear side 2200 of the electrical contact part 2000 is shown in FIG. 29B, and the back side of each external terminal 2100 of the electrical contact part 2000 may be further disposed with an electrical connection end 2300. The electrical connection end 2300 may be a protrusion structure with a certain length, which may be a spring, a spring sheet or the like with elasticity, or a metal protrusion without elasticity, which may be abutted against the surface of the chip terminal 311. When the chip terminal 311 on the consumable chip 310 is an embedded structure, that is, a certain distance is between the chip terminal 311 and the outer surface of the developing cartridge 300, or when a tolerance dimension is between the developing cartridge 300 and the inside of the packaging part 10a which may result in shaking during transportation process, it may cause a gap between the external terminal 2100 and the chip terminal 311 and affect subsequent contact between the external terminal 2100 and the chip terminal 311. The electrical connection end 2300 with a protrusion structure may effectively reduce the gap between the external terminal 2100 and the chip terminal 311 to ensure stable contact between the external terminal 2100 and the chip terminal 31, such that a direct and stable electrical connection may be formed between the external terminal 2100 and the chip terminal 311.

When corresponding contact between the external terminal 2100 and the chip terminal 311 is indirect contact, as shown in FIG. 30, after the developing cartridge 300 is loaded into the accommodation part 17a from the open end 18a, and in the case that a certain distance is between the developing cartridge 300 and the accommodation part 17a due to structural dimensions, an intermediate part 3000 may need to be disposed between the developing cartridge 300 and the packaging part 10a at this point. The intermediate part 3000 may be connected to the electrical contact part 2000 and the consumable chip 310 respectively, so that the electrical contact part 2000 and the consumable chip 310 may form electrical connection. The structure and arrangement form of the intermediate part 3000 may not be limited; and the intermediate part 3000 may be a conductive wire, a conductive steel sheet or other conductive elastic parts. In addition, the intermediate part 3000 disposed may be used for detachable connection to the packaging part 10a and may also be used for detachable connection to the developing cartridge 300, which may not be limited herein. Furthermore, when the intermediate part 3000 is a wire structure, a fixing frame may be disposed at each end of the intermediate part 3000 to be configured (e.g., plugged) on the surface of the consumable chip 310 and the rear side 2200 of the electrical contact part 2000, respectively, such that two ends of the intermediate part 3000 may respectively form stable electrical connection with the consumable chip 310 and the electrical contact part 2000.

When the data in the consumable chip 310 needs to be read and written, it is only necessary to electrically connect the data read and write device to the electrical contact part 2000 on the packaging part 10a. That is, the electrical connection end on the data read and write device (which is provided with electrical connection structures such as contact pins) may be connected with the external terminal 2100 on the electrical contact part 2000 to form electrical contact, such that the electrical connection end on the data read and write device may be electrically connected with the chip terminal 311 on the consumable chip 310. Therefore, it is no need to unpack the packaging part 10a, that is, the reading and writing of the data stored in the consumable chip 310 may be performed without breaking the seal of the open end 18a. After the reading and writing is completed, there is no need to re-seal the open end 18a, or even a new packaging part 10a may not need to be replaced, which may effectively save the time cost, labor cost, and even material cost of reading and writing data and may be environmentally friendly and avoid unnecessary waste.

### Exemplary Embodiment Thirteen

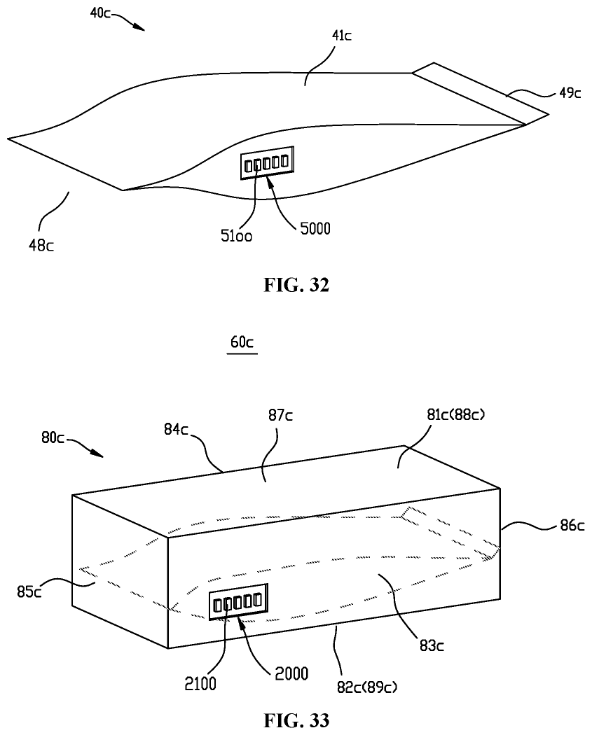

As shown in FIGS. 31-32, the packaging part 40c according to one embodiment may be a packaging bag structure. The packaging part 40c may be a packaging bag with deformable external dimension formed by paper, foamed cotton sheet, film, air-filled film and the like; and the packaging part 40c may be, for example, a paper bag, a pearl cotton bag, a plastic bag, a bubble bag or the like. Specific structure of the packaging part 40c is described below by taking a plastic bag as an example. The packaging part 40c may include an accommodation part 41c, for example, a rectangular structure with a long side and a wide side in the external structure. The packaging part 40c may be disposed with an open end 48c for loading the consumable cartridge into the packaging part 40c. The open end 48c may be disposed at one of the two ends along the length direction or width direction of the packaging part 40c, and the other end may correspondingly form a closed end 49c. The sealing form of the open end 48c may also not be limited, such as thermocompression plastic sealing. Accordingly, the accommodation part 41c may be formed between the open end 48c and the closed end 49c. After the developing cartridge 300 is loaded into the accommodation part 41c from the open end 48c, and the open end 48c is sealed, the packing of the developing cartridge 300 by the packaging part 40c may be completed.

According to one embodiment, an electrical contact part 5000 may also be disposed on the packaging part 40c. As shown in FIG. 32, the electrical contact part 5000 may be installed on the packaging part 40c and exposed in the packaging part 40c, and the position of the electrical contact part on the packaging part 40c may not be limited. Optionally, the position of the electrical contact part 5000 in one embodiment may correspond to the position of the chip 310 on the developing cartridge 300. Specific structure of the electrical contact part 5000 in one embodiment may use a same structure as the electrical contact part 2000 in exemplary embodiment twelve. The electrical contact part 5000 may include at least one external terminal 5100. At least one external terminal 5100 may be in corresponding contact with at least one chip terminal 311 on the consumable chip 310 to form electrical connection. After the external terminal 5100 is electrically connected to the read and write device, the data read and write device may perform reading and writing operation on the consumable chip by being electrically connected to the external terminal 5100. When the electrical contact part 5000 is electrically connected with the consumable chip 310, data in the memory of the consumable chip 310 may be read and written through the electrical contact part 5000. Since the packaging part 40c has deformable external dimension, when the corresponding contact between the external terminal 5100 and the chip terminal 311 is direct contact, a locking button structure (not shown) may be disposed on the rear side of the electrical contact part 5000 (that is, inside the packaging part 40c). The electric contact part 5000 may be engaged on the consumable chip 310 by engagement between the corresponding engaging part (not shown) of the developing cartridge 300 and the locking button, such that corresponding contact between the external terminal 5100 and the chip terminal 311 in one embodiment may be stable and not easily disconnected.

In addition, corresponding contact between the external terminal 5100 and the chip terminal 311 in one embodiment may also use the indirect contact as shown in FIG. 30 in exemplary embodiment twelve. That is, the intermediate part 3000 may be disposed between the developing cartridge 300 and the packaging part 40c. The intermediate part 3000 may be a wire structure or may be a conductive steel sheet or other conductive elastic parts, which may not be described in detail herein. As a result, two ends of the intermediate part 3000 may respectively form stable electrical connection with the consumable chip 310 and the electrical contact part 5000.

When the data in the consumable chip needs to be read and written, it may only need to connect the data read and write device to the electrical contact part 5000 on the packaging part 40c. That is, the electrical connection end on the data read and write device may be connected with the external terminal 5100 on the electrical contact part 5000 to form electrical contact, such that the electrical connection end on the data read and write device may be electrically connected with the chip terminal 311 on the consumable chip 310. Therefore, it is no need to unpack the packaging part 40c, that is, the reading and writing of the data stored in the consumable chip 310 may be performed without breaking the seal of the open end 48c. After the reading and writing is completed, there is no need to re-seal the open end 48c, or even a new packaging part 40c may not need to be replaced, which may effectively save the time cost, labor cost, and material cost of reading and writing data and may be environmentally friendly and avoid unnecessary waste.

### Exemplary Embodiment Fourteen

The packaging part according to one embodiment may be a packaging part assembly including a first packaging part and a second packaging part. The first packaging part may be used for accommodating the developing cartridge 300, and the second packaging part may be sleeved outside the first packaging part. The first packaging part may be the packaging bag structure described in exemplary embodiment thirteen, and the second packaging part may be the packaging box structure described in exemplary embodiment twelve. After the developing cartridge 300 is first placed into the first packaging part of the packaging bag structure for sealing, the developing cartridge 300 packaged with the first packaging part may then be placed into the second packaging part of the packaging box structure for sealing, thereby forming a sleeve-type packaging manner. This packaging manner may greatly increase the sealing but may also increase the complexity of the read and write operation on the chip in the developing cartridge.

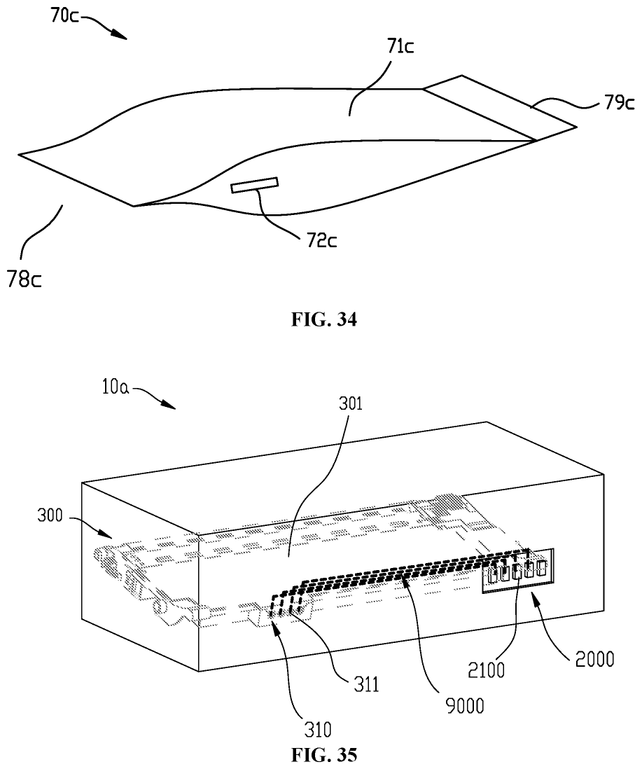

As shown in FIGS. 33 and 34, the packaging part 60c according to one embodiment may include a first packaging part 70c and a second packaging part 80c. The second packaging part 80c may have a same packaging box structure as the packaging part 10a in exemplary embodiment twelve, including a top surface 81c, a bottom surface 82c, a front surface 83c and a rear surface 84c along the width direction and including a left surface 85c and a right surface 86c along the length direction. The second packaging part 80c may include a receiving part 87c, an open end 88c on the top surface 81c and a closed end 89c on the bottom surface 82c. The second packaging part 80c may also be disposed with the electrical contact part 2000 having the external terminal 2100 as in exemplary embodiment twelve. The first packaging part 70c may be a packaging bag structure, including an accommodation part 71c, an open end 78c, and a closed end 79c. In addition, a passing through part 72c may also be disposed on the first packaging part 70c; and the passing through part 72c may be an opening structure that the surrounding of the passing through part may be sealed. After the developing cartridge 300 is loaded into the first packaging part 70c, and after the developing cartridge 300 and the first packaging part 70c are further loaded into the second packaging part 80c, a direct and stable electrical connection may be formed between the chip terminal 311 of the developing cartridge 300 and the external terminal 2100 of the second packaging part 80c through the passing through part 72c. For example, when corresponding contact between the external terminal 2100 and the chip terminal 311 is direct contact, after the chip terminal 311 of the developing cartridge 300 is directly exposed by the passing through part 72c of the opening structure, the periphery of the chip terminal 311 may be sealed, which may have the effect of preventing water vapor from entering the developing cartridge 300. Next, the locking button (not shown) on the rear side of the electrical contact part 2000 may be engaged with the engaging part on the developing cartridge body covered with the first packaging part 70c through a same locking button structure in exemplary embodiment thirteen, such that the electrical contact part 2000 may be engaged on the consumable chip 310. Therefore, corresponding contact between the external terminal 2100 and the chip terminal 311 may be stable and not easily disconnected. When corresponding contact between the external terminal 2100 and the chip terminal 311 is indirect contact, the intermediate part 3000 may be disposed between the developing cartridge 300 and the second packaging part 80c as in exemplary embodiment twelve, and the intermediate part 3000 may pass through the passing through part 72c of the first packaging part 70c. Therefore, two ends of the intermediate part 3000 passing through the first packaging part 70c may form stable electrical connection with the consumable chip 310 and the electrical contact part 2000, respectively.

### Exemplary Embodiment Fifteen

On the basis of above-mentioned embodiments, exemplary embodiment fifteen further provides a general-purpose packaging part. According to the packaging part in one embodiment, the accommodation part may be used to accommodate a consumable cartridge with consumable chips in different positions. The electrical connecting part disposed between the consumable cartridge and the packaging part may connect the consumable chips with different positions to the electrical contact part on the packaging part, thereby forming electrical connection. As shown FIG. 35, taking the packaging part 10a in exemplary embodiment twelve as an example, an intermediate part 9000 may be disposed on the fixing frame (not shown). The intermediate part 9000 may be a conductive wire, a conductive steel sheet or other conductive elastic parts. Optionally, the intermediate part 9000 may be a wire structure, which may be installed (e.g., plugged) on the surface of the consumable chip 310 of the developing cartridge 300 and the rear side 2200 of the electrical contact part 2000. At this point, same as the structure in exemplary embodiment twelve, a wire structure of sufficient length may only need to be disposed, such that the packaging part may be suitable for accommodating consumable cartridges with chips in different positions.

In addition, the fixing frame may also be installed on the cartridge body 301 of the developing cartridge 300 along the length or width direction of the developing cartridge 300 and make the intermediate part 9000 of the wire, steel sheet or other conductive elastic structure installed on the fixing frame. During an assembly process, the intermediate part 9000 may be preferably disposed on the fixing frame; and then the fixing frame may be installed on the developing cartridge 300; and each terminal installed between the intermediate part 9000 and the consumable chip 310 may be further aligned, which may not only facilitate the installation during the assembly process, but also make component arrangement organized and orderly, thereby optimizing the assembly process.

In addition, the intermediate part 9000 may also be arranged on a fixing frame (not shown) with a sliding rail. The fixing frame may be installed on the cartridge body 301 of the developing cartridge 300 along the length or width direction of the developing cartridge 300. The contact end of the intermediate part 9000 and the surface of the consumable chip 310 may be movably disposed on the fixing frame, and/or the contact end of the intermediate part 9000 and the electrical contact part 2000 (rear side 2200) of the packaging part 10a may be movably disposed on the fixing frame along the sliding rail. Before installing the developing cartridge 300 into the packaging part 10a, the position of the contact end of the intermediate part 9000 and the surface of the consumable chip 310 may be adjusted, and the position of the contact end of the intermediate part 9000 and the electrical contact part 2000 may be pre-adjusted; and the developing cartridge 300 may be installed into the packaging part 10a, such that it may realize that the intermediate part 9000 may form stable electrical connection between the consumable chip 310 and the electrical contact part 2000. When the packaging part includes the first packaging part and the second packaging part, the packaging may be performed according to description of exemplary embodiment fourteen, which may not be described in detail herein.

### Exemplary Embodiment Sixteen

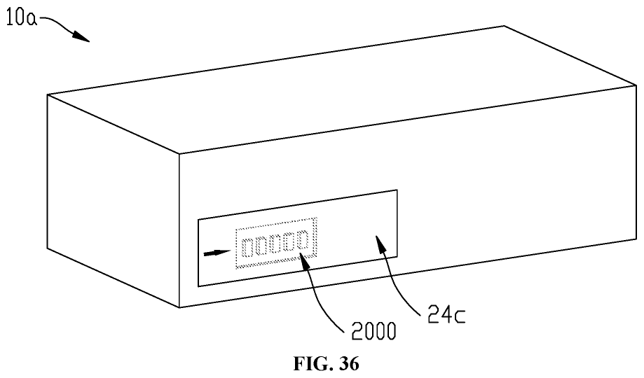

According to above-mentioned embodiments, a protection part may be further disposed on the packaging part configured with the electrical contact part, as shown in FIG. 36. A protection part 24c may be peeled off from the outer surface of the packaging part 10 and cover the surface of the electrical contact part 2000, which may protect the electrical contact part from contamination, moisture or undesired electrical connection when data reading and writing operations on the consumable chip are not performed.

In addition, the number of external terminals of the electrical contact part on the packaging part is greater than or equal to the number of chip terminals on the consumable cartridge, as shown in FIGS. 29A, 30, and 35. In such way, a more flexible electrical connection manner and universality may be provided. When the number of external terminals of the electrical contact part is greater than the number of chip terminals on the consumable cartridge, after the packaging is completed, relevant operations for instructing invalidity including covering and the like may be performed on the external terminals at the packaging part which are not connected to the chip terminals, such that the external terminals with function may be exposed, and the external terminals that may be read and written may be effectively identified to prevent mis-determination.

In one embodiment, the protection part 24c may be disposed. That is, the protection part 24c may be the peelable part in one embodiment that the operable part is configured as the opening. The protection part 24c may be completely peeled off from the surface of the packaging part as exemplary embodiment three, and specific peeling structure of the protection part 24c may refer to exemplary embodiment four; and the protection part 24c may also be incompletely peeling structure matching in exemplary embodiments seven to nine, and specific peeling structure matching of the protection part 24c may be same as those in corresponding embodiments, which may not be limited herein.

In addition, the method for reading and writing the consumable chip inside the packaging part as in exemplary embodiments ten to eleven may be also applicable to the packaging part using the structure matching of the electrical contact part, which may not be described in detail herein.

Optionally, in the packaging part that uses the structure matching of the electrical contact part, the intermediate part may be slid or fixed to meet the position requirements of different operable parts in the packaging part. The chip packaging part used by the packaging part with the opening structure matching and corresponding structure matching form with the packaging part may also be used to other packaging parts, which may not be described in detail herein.

It should be emphasized herein that, the operable parts disposed may include, but may not be limited to, above-mentioned structure matching forms such as electrical contact parts and openings, may also be the operable parts formed by a combination of electrical contact parts and openings (electrical contact parts are disposed in the openings) or other structures, which may not be described in detail herein.

From above-mentioned embodiments, it may be seen that the solutions according to the present disclosure may achieve at least following beneficial effects.

The present disclosure provides the packaging part. By disposing the operable part on the packaging part, without unpacking and repacking the consumable cartridge, read and write operation may be performed on the chip in the consumable cartridge inside the packaging part, and structural processing may be operably performed on the consumable cartridge. In particular, for combined packaging manner of sleeve-type and multiple consumable cartridges, the solution of the present disclosure may be simpler and more convenient.

The present disclosure also provides the packaging assembly including the packaging part and the part to-be-packaged. The packaging assembly has same advantages as above-mentioned packaging parts, which may not be described in detail herein.

The present disclosure also provides the chip read and write method, which has same advantages as above-mentioned packaging part, which may not be described in detail herein.

It may be understood that above-mentioned general description and detailed description may be exemplary only and may not limit the present disclosure.

The above descriptions are only preferred embodiments of the present disclosure and are not intended to limit the present disclosure. Any modification, equivalent replacement, improvement and the like made within the spirit and principle of the present disclosure shall be included within the protection scope of the present disclosure.

What is claimed is:

1. A packaging part, comprising:
a hollow accommodation part, wherein a size and a shape of the hollow accommodation part is suitable for accommodating a part to-be-packaged; and the part to-be-packaged includes a data storage part; and
an operable part, wherein the data storage part and/or the part to-be-packaged in the hollow accommodation is capable of being operated from an outside of the packaging part through the operable part.

2. The packaging part according to claim 1, wherein:
the operable part includes an electrical contact part configured to be electrically connected to the data storage part.

3. The packaging part according to claim 2, further including:
an intermediate part, configured to electrically connect the electrical contact part with the data storage part.

4. The packaging part according to claim 3, wherein:
the intermediate part is configured to be detachably connected to the packaging part or the part to-be-packaged.

5. The packaging part according to claim 1, wherein:
the data storage part is detachably connected to the part to-be-packaged; and the packaging part further includes a chip packaging part configured to packaging part the data storage part.

6. The packaging part according to claim 5, wherein:
the chip packaging part includes an opening part, and a consumable chip is capable of being operated from the outside of the packaging part through the opening part and the operable part; and
the chip packaging part further includes a limiting part; and the limiting part is capable of being abutted against the packaging part for limiting a movement of the chip packaging part relative to the packaging part.

7. The packaging part according to claim 5, further including:
a receiving part, configured to accommodate the chip packaging part.

8. The packaging part according to claim 1, wherein:
the packaging part includes a first packaging part and a second packaging part; the first packaging part is configured to accommodate the part to-be-packaged; and the second packaging part is capable of being sleeved on an outside of the first packaging part.

9. The packaging part according to claim 8, wherein:
the first packaging part includes a passing through part; and the passing through part is an opening structure disposed on the first packaging part and configured to electrically connect the data storage part with the outside of the packaging part.

10. The packaging part according to claim 1, wherein:
the packaging part includes a peelable part; the peelable part at least covers the operable part for limiting exposure of the operable part to the outside of the packaging part; the peelable part includes a peeling part and a peeling guide part; and the peeling guide part is configured to detachably connect the peeling part with the packaging part.

11. The packaging part according to claim 10, wherein:
the peeling guide part is a porous structure or a slit structure, disposed between the packaging part and the peeling part.

12. The packaging part according to claim 10, wherein:
the peeling guide part includes a peeling-start part; and the peeling-start part is disposed on the peeling part at a side away from a connecting part and configured to start to peel the peeling guide part to disconnect the peeling part from the packaging part.

13. The packaging part according to claim 10, wherein:
the peelable part further includes a connecting part; and
the connecting part connects the peeling part with the packaging part; and when the peeling guide part detaches the peeling part from the packaging part, the connecting part limits the peeling part from falling off the packaging part.

14. The packaging part according to claim 13, wherein:
the peeling part includes a first peeling part and a second peeling part; and the connecting part includes a first connecting part and a second connecting part;
the first peeling part is integrally formed with the packaging part through the first connecting part; the second peeling part is integrally formed with the packaging part through the second connecting part; and the first peeling part and the second peeling part are detachably connected through the peeling guide part, the first peeling part and the packaging part are detachably connected through the peeling guide part, and the second peeling part and the packaging part are detachably connected through the peeling guide part.

15. The packaging part according to claim 1, wherein:
the packaging part further includes an identification part which is capable of being identified and configured to electrically connect the data storage part with an external data read and write device.

16. A packaging assembly, comprising:
a packaging part and a part to-be-packaged, wherein:
the packaging part includes a hollow accommodation part, wherein a size and a shape of the hollow accommodation part is suitable for accommodating a part to-be-packaged, and the part to-be-packaged includes a data storage part; and further includes an operable part, wherein the data storage part and/or the part to-be-packaged in the hollow accommodation is capable of being operated from an outside of the packaging part through the operable part.

17. The packaging assembly according to claim 16, wherein:
the part to-be-packaged is a consumable cartridge, and the data storage part is a consumable chip.

18. A chip read and write method, wherein the method is configured to read and write data of a data storage part in a packaging assembly; the packaging assembly includes a packaging part; the packaging part includes the data storage part; and the packaging part is disposed with an operable part, the method comprising:
placing the packaging assembly on an operating table;
identifying a position of the packaging assembly; and according to an identification result, determining whether adjusting a placement position of the packaging assembly relative to the operating table and/or a position of the packaging assembly relative to the data read and write device is needed; and
electrically connecting the data storage part with the data read and write device through the operable part.

19. The chip read and write method according to claim 18, wherein:
the packaging assembly has a preset placement position on the operating table, such that the data storage part and the data read and write device are capable of being electrically connected to each other; and
the position of the packaging assembly is identified; when it is identified that the packaging assembly is placed on the preset placement position, the identification result is “Yes”; and when it is identified that the packaging assembly is not placed on the preset placement position, the identification result is “No”.

20. The chip read and write method according to claim 19, wherein:
when the identification result is “Yes”, the data storage part is electrically connected with the data read and write device; and
when the identification result is “No”, a position of the operating table and/or the position of the packaging assembly is adjusted until the identification result is “Yes”; or a position of the data read and write device is adjusted until the identification result is “Yes”.
